(19) United States
(12) Patent Application Publication
(10) Pub. No.: US 2025/0238901 A1
(43) Pub. Date: Jul. 24, 2025

(54) METHOD AND ELECTRONIC DEVICE FOR GENERATING A PANORAMIC IMAGE

(71) Applicant: SAMSUNG ELECTRONICS CO., LTD., Suwon-si (KR)

(72) Inventors: Choice CHOUDHARY, Tohana (IN); Sandeep Singh SPALL, Moga (IN); Rupesh KASHYAP, Noida (IN); Anshuman CHAURSIYA, Siddhartha Nagar (IN)

(73) Assignee: SAMSUNG ELECTRONICS CO., LTD., Suwon-si (KR)

(21) Appl. No.: 19/174,359

(22) Filed: Apr. 9, 2025

Related U.S. Application Data
(63) Continuation of application No. PCT/KR2023/013955, filed on Sep. 15, 2023.

(30) Foreign Application Priority Data
Oct. 20, 2022 (IN) 202211059997

(51) Int. Cl. G06T 5/50; G06V 10/44; G06V 10/74

(52) U.S. Cl. CPC G06T 5/50; G06V 10/44; G06V 10/761; G06T 2207/20221

(57) ABSTRACT

A method for panoramic image generation includes obtaining a plurality of frames corresponding to an environment using an imaging device; receiving inertial sensor data of the imaging device associated with the plurality of frames; obtaining first features associated with a first frame of the plurality of frames and second features associated with a second frame of the plurality of frames; obtaining a first partial region of the first frame and a second partial region of the second frame, based on a first comparison of the first features and the second features; generating a similarity between a respective frame of the plurality of frames and at least one adjacent frame to the respective frame based on obtained features associated with each frame; and generating a panoramic image by merging the plurality of frames based on the similarity between each frame of the plurality of frames.

### CROSS-REFERENCES TO RELATED APPLICATIONS

This application claims priority to International Application No. PCT/KR2023/013955, filed on Sep. 15, 2023, with the Korean Intellectual Property Office, which claims priority from Indian Patent Application number 202211059997, filed on Oct. 20, 2022, with the Indian Intellectual Property Office, the disclosures of which are incorporated herein by reference in their entireties.

### BACKGROUND

### 1. Technical Field

The present disclosure generally relates to image processing, and more particularly relates to method and electronic device for generating a panoramic image using an imaging device.

### 2. Background Art

A panoramic image is a wide-angle view or a representation of a physical space. Typically, imaging devices are only capable of taking pictures within a limited field of view and are unable to capture an image with elongated field of view. In such scenarios, panoramic imaging resolves the problem by combining images taken from various sources or different point of views into a single image. The panoramic imaging may even cover fields of view of up to 360 degrees.

To generate a panoramic image, multiple photographic images with overlapping fields of view are obtained by rotating the imaging device and then the photographic images are stitched together. However, a quality of a final panoramic image is highly dependent on a precision of “slow and steady” movement of the imaging device along an axis while obtained the view. Further, in a sparsely distributed environment, generation of the panoramic image consumes a lot of resources and time. Specifically, generating an adaptive, fast, and high-quality panoramic image is always a challenging task for the imaging device.

In general, each of a plurality of image frames obtained to generate the panoramic image is processed wholly, which results in slower panoramic generation. FIG. 1 illustrates a generation of a panoramic image, according to current state of the art. Particularly, FIG. 1 illustrates that to generate a panoramic image using four illustrated frames i.e., Frame 1, Frame 2, Frame 3, and Frame 4, each of four frames are processed wholly to generate the panoramic image which may require a lot of computation time. Therefore, there is a need to provide and method and electronic device for efficiently generating panoramic image with a reduced computation time.

FIG. 2 illustrates generation of a panoramic image with inappropriate surface selection, according to a conventional technique. It has been illustrated that conventional techniques for generating panoramic images fail to accurately identify a panoramic surface for panoramic image which results in a disruptive final image. For instance, in the FIG. 2, it has been illustrated that the panoramic surface has been selected as circular instead of linear, resulting in a distorted panoramic image. Thus, such conventional technique fails to serve the purpose of providing an accurate and elongated field of view.

FIG. 3 illustrates a generation of a panoramic image with wrong frame alignment, according to a conventional technique. FIG. 3 illustrates sequentially aligned frames i.e., Frame 1, Frame 2, and Frame 3, which are stitched together to generate a panoramic image. However, the conventional technique used for generation of the panoramic image fails to identify a current frame alignment and results in a distorted final image.

Also, conventional techniques for generating the panoramic image faces additional challenges such as, a difficulty in panoramic stabilization, an abrupt closure of panorama during a 360-degree view panorama, wrong alignment of frames during panoramic image generation, and non-adaptive frame capture rate by the imaging device.

FIG. 4 illustrates an unsupervised deep image stitching technique, according to a conventional technique. According to the unsupervised deep image stitching technique, a stitched image is reconstructed based on a feature to pixel mapping technique. The unsupervised deep image stitching technique learns deformation rules of image stitching to enhance image resolution. However, such unsupervised deep image stitching technique fails to perform appropriate image alignment and requires a lot of frames for panoramic image generation.

FIG. 5 illustrates a direct stitching technique, according to a conventional technique. The direct stitching technique depends on a comparison of pixels intensities of images with each other. Such direct stitching technique minimizes a sum of absolute difference between overlap ping pixels. However, such direct stitching technique requires very slow movement of the imaging device, to achieve a high overlapping region. Further, such direct stitching technique requires high computational power and human interaction.

Accordingly, there is a need to overcome at least the above challenges associated with generation of panoramic images. Further, there is a need for a technique which can process a plurality of images to generate a panoramic image effectively and efficiently.

### SUMMARY

According to an aspect of the disclosure a method of video processing is provided. The method includes obtaining a plurality of frames corresponding to an environment using an imaging device; receiving inertial sensor data of the imaging device associated with the plurality of frames; obtaining first features associated with a first frame of the plurality of frames and second features associated with a second frame of the plurality of frames; obtaining a first partial region of the first frame and a second partial region of the second frame, based on a first comparison of the first features and the second features; for each subsequent frame after the second frame: identifying a next partial region of a next frame, based on at least one of partial regions of one or more previously obtained frames and the inertial sensor data, obtaining next features associated with the next frame based on the next partial region of the next frame, and updating the next partial region of the next frame based on a second comparison of the next features and features associated with a previously obtained frame; generating a similarity between a respective frame of the plurality of frames and at least one adjacent frame to the respective frame based on obtained features associated with each frame; and generating a panoramic image by merging the plurality of frames based on the similarity between each frame of the plurality of frames.

According to an aspect of the disclosure, an electronic device for image processing is provided. The electronic device includes memory; at least one processor communicably coupled to the memory. The at least one processor is configured to obtain a plurality of frames corresponding to an environment using the imaging device; receive inertial sensor data of the imaging device associated with the plurality of frames; obtain a first features associated with a first frame of the plurality of frames and a second features associated with a second frame of the plurality of frames; obtain a first partial region of the first frame and a second partial region of the second frame, based on a first comparison of the first features and the second features; for each subsequent frame after the second frame: identify a next partial region of a next frame based on at least one of partial region of one or more previously obtained frames and the inertial sensor data, determine next features associated with the next frame based on the next partial region of the next frame, and update the next partial region of the next frame based on a second comparison of the next features and features associated with the previously obtained frame; generate a similarity a respective frame of the plurality of frames and at least one adjacent frame to the respective frame based on obtained features associated with each frame; and generate a panoramic image by merging the plurality of frames based on the similarity between each frame of the plurality of frames.

According to an aspect of the disclosure, a non-transitory computer readable medium for storing computer readable program code or instructions which are executable by a processor to perform a method. The method includes obtaining a plurality of frames corresponding to an environment using an imaging device; receiving inertial sensor data of the imaging device associated with the plurality of frames; obtaining first features associated with a first frame of the plurality of frames and second features associated with a second frame of the plurality of frames; obtaining a first partial region of the first frame and a second partial region of the second frame, based on a first comparison of the first features and the second features; for each subsequent frame after the second frame: identifying a next partial region of a next frame, based on at least one of partial regions of one or more previously obtained frames and the inertial sensor data, obtaining next features associated with the next frame based on the next partial region of the next frame, and updating the next partial region of the next frame based on a second comparison of the next features and features associated with a previously obtained frame; generating a similarity between a respective frame of the plurality of frames and at least one adjacent frame to the respective frame based on obtained features associated with each frame; and generating a panoramic image by merging the plurality of frames based on the similarity between each frame of the plurality of frames.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 illustrates a generation of a panoramic image, according to a conventional technique;

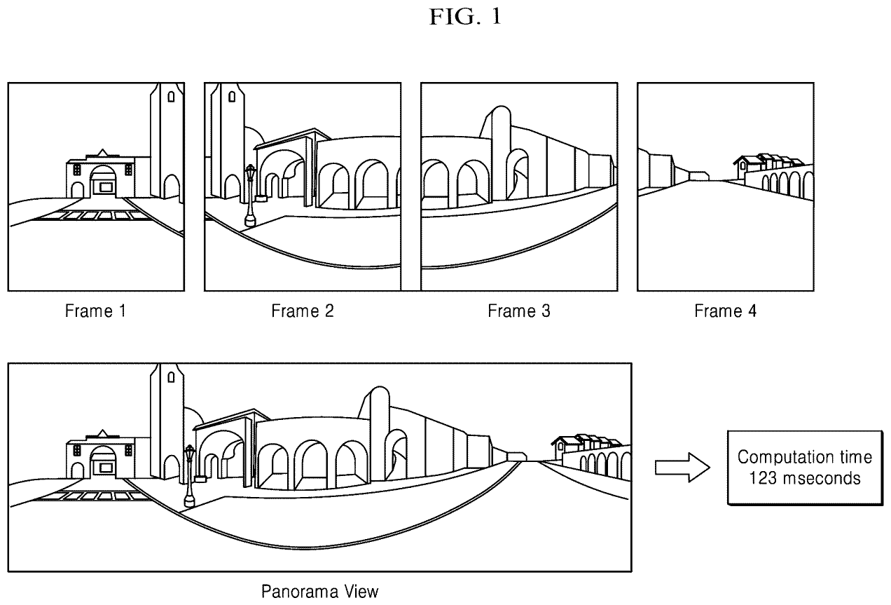

FIG. 2 illustrates a generation of a panoramic image with inappropriate surface selection, according to a conventional technique;

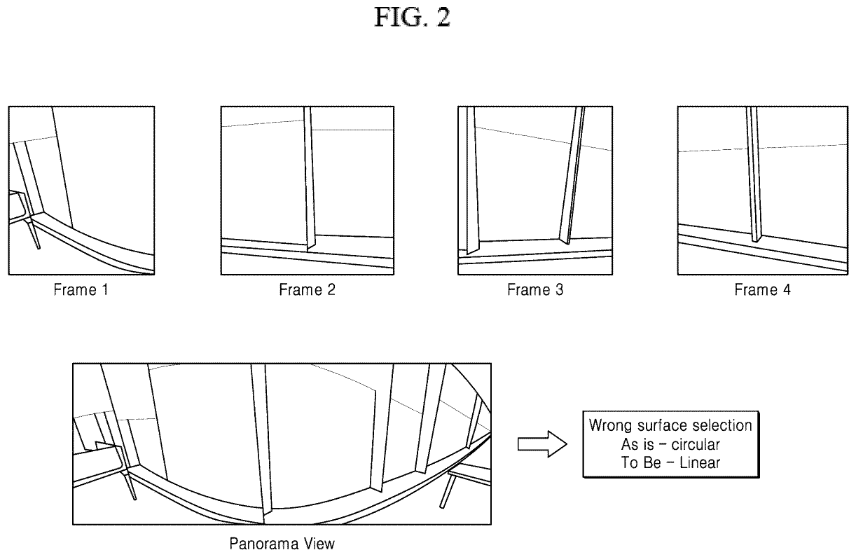

FIG. 3 illustrates a generation of a panoramic image with wrong frame alignment, according to a conventional technique;

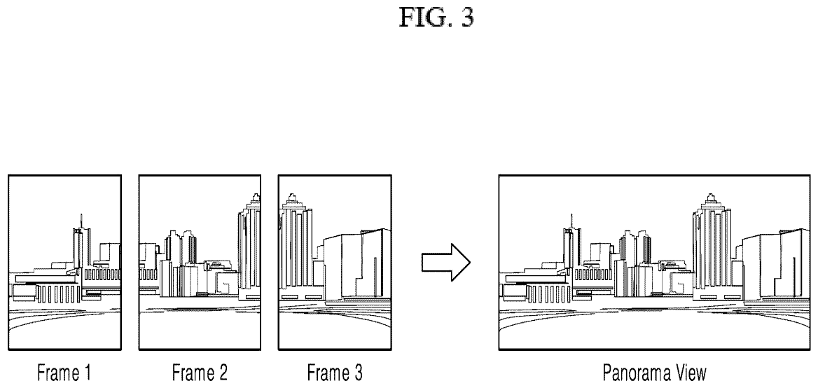

FIG. 4 illustrates an unsupervised deep image stitching, according to a conventional technique;

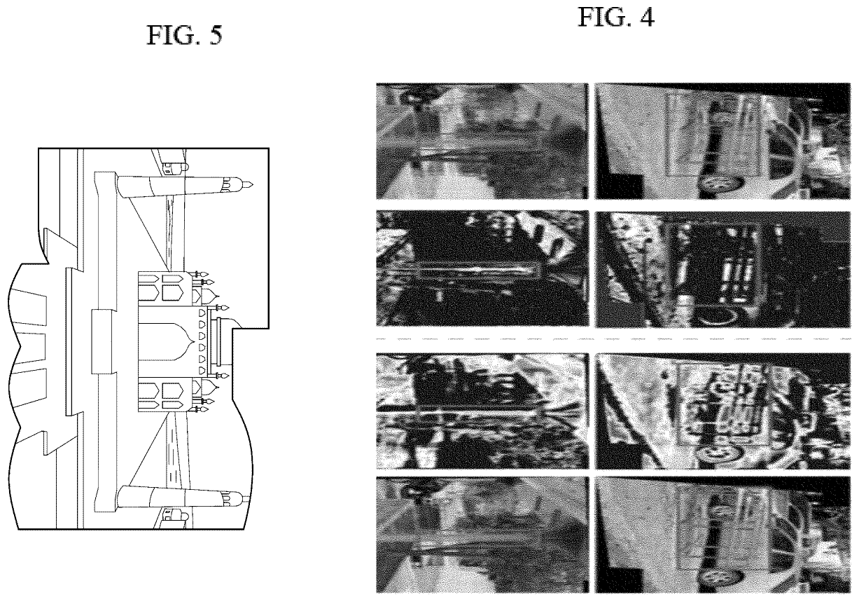

FIG. 5 illustrates a direct image stitching, according to a conventional technique;

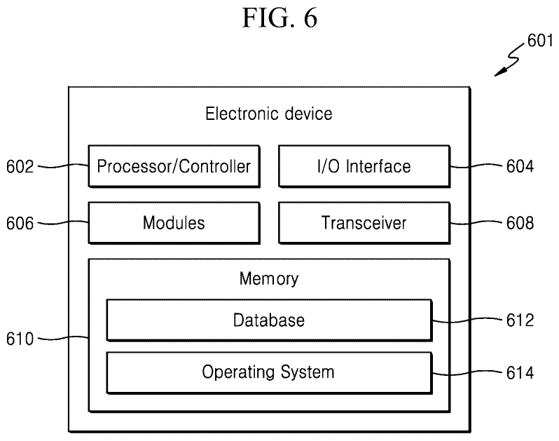

FIG. 6 illustrates a schematic block diagram of an electronic device for generating a panoramic image, according to an embodiment of the present disclosure;

FIG. 7 illustrates a schematic architecture of the electronic device for generating the panoramic image using an imaging device, according to an embodiment of the present disclosure;

FIG. 8 illustrates a process flow depicting a method of generating the panoramic image, according to an embodiment of the present disclosure;

FIGS. 9A and 9B illustrate elimination of artifacts from image frames by a frame calibration module, according to an embodiment of the present disclosure;

FIG. 10 illustrates of a schematic process flow for generating rotational and translation matrices, according to an embodiment of the present disclosure;

FIG. 11 illustrates of a schematic workflow of a frame calibration module, according to an embodiment of the present disclosure;

FIGS. 12A and 12B illustrate partial region identification by a partial feature detection module, according to an embodiment of the present disclosure;

FIG. 13 illustrates a process flow of a method performed by the partial feature detection module, according to an embodiment of the present disclosure;

FIG. 14 illustrates identification of inliers and outliers in two frames, according to an embodiment of with the present disclosure;

FIG. 15 illustrates partial feature registration, according to an embodiment of the present disclosure;

FIG. 16 illustrates a process flow of a method performed by an advanced RANSAC module, according to an embodiment of the present disclosure;

FIG. 17A-17C illustrate 2-D grid generation by the advanced RANSAC module, according to an embodiment of the present disclosure;

FIGS. 18A-18C illustrate selection of the adaptive panoramic surface by an adaptive panoramic surface selection module, according to embodiments of the present disclosure;

FIG. 19 illustrates a process flow of a method performed by the adaptive panoramic surface selection module for selection of the adaptive panoramic surfaces, according to an embodiment of the present disclosure;

FIG. 20 illustrates panoramic surfaces, according to an embodiment of the present disclosure;

FIG. 21 illustrates a process flow of a method performed by the adaptive panoramic surface selection module, according to an embodiment of the present disclosure;

FIG. 22 illustrates selection of a reference frame by a dynamic reference frame selection module, according to an embodiment of the present disclosure;

FIG. 23 illustrates selection of a reference frame by the dynamic reference frame selection module, according to an embodiment of the present disclosure;

FIG. 24 illustrates selection of a reference frame by the dynamic reference frame selection module, according to an embodiment of the present disclosure;

FIG. 25 illustrates selection of a reference frame by the dynamic reference frame selection module, according to an embodiment of the present disclosure;

FIG. 26 illustrates selection of a reference frame by the dynamic reference frame selection module, according to an embodiment of the present disclosure;

FIG. 27 illustrates selection of a reference frame by the dynamic reference frame selection module, according to an embodiment of the present disclosure;

FIG. 28 illustrates generation of recommendations by a recommendation module, according to an embodiment of the present disclosure;

FIG. 29 illustrates a process flow of a method performed by the recommendation module, according to an embodiment of the present disclosure;

FIG. 30 illustrates impact of recommendations by the recommendation module, according to an embodiment of the present disclosure;

FIG. 31 illustrates frame calibration by an ISP frame capture calibration module, according to an embodiment of the present disclosure; and

FIGS. 32A-32C illustrate a process of a method for generating a panoramic image, according to an embodiment of the present disclosure.

### DETAILED DISCLOSURE

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in an electronic device, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

To further clarify the advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

Further, skilled artisans will appreciate that elements in the drawings are illustrated for simplicity and may not have necessarily been drawn to scale. For example, the flow charts illustrate the method in terms of the most prominent operations involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein. Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprise”, “comprising”, “include”, “including” or any other variations thereof, are intended to cover a non-exclusive inclusion, such that a process or method that comprises a list of steps or operations does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The terms like “panorama”, “panorama view” and “panoramic image” may be used interchangeably throughout the description. Further, the terms like “frames”, “image frames” and “frames” may be used interchangeably throughout the description.

Moreover, the terms “camera” and “imaging device” may be used interchangeably throughout the description. Similarly, the term like “adjacent frames” and “neighboring frames” may be used interchangeably.

Embodiments of the present disclosure are directed towards a method and an electronic device for generating a panoramic image using an imaging device. A key objective of the present disclosure is to effectively generate a panoramic image using a rate of change of inliers and outliers, and a distance of farthest outlier and inlier from each edge, among a plurality of frames which are aligned on edges. Further, the present disclosure is directed towards applying an improved Random sample consensus (RANSAC) technique calculating an affine and/or a similarity matrix between two frames based on the rate of change of inliers and outliers in previous obtained frames.

Further, embodiments of the present disclosure are directed towards performing feature detection partial regions of adjacent frames to reduce computational resources and time.

Moreover, embodiments of the present disclosure are directed toward determining a final panoramic surface in advance based on one or more parameters associated with a user and/or the imaging device, to reduce conversion from one plane to another plane, and accurately generate the panoramic image.

Furthermore, embodiments of the present disclosure are directed toward modulating frame capture rate such that a time required for generating panoramic image can be reduced without impacting a quality of the generated panoramic image.

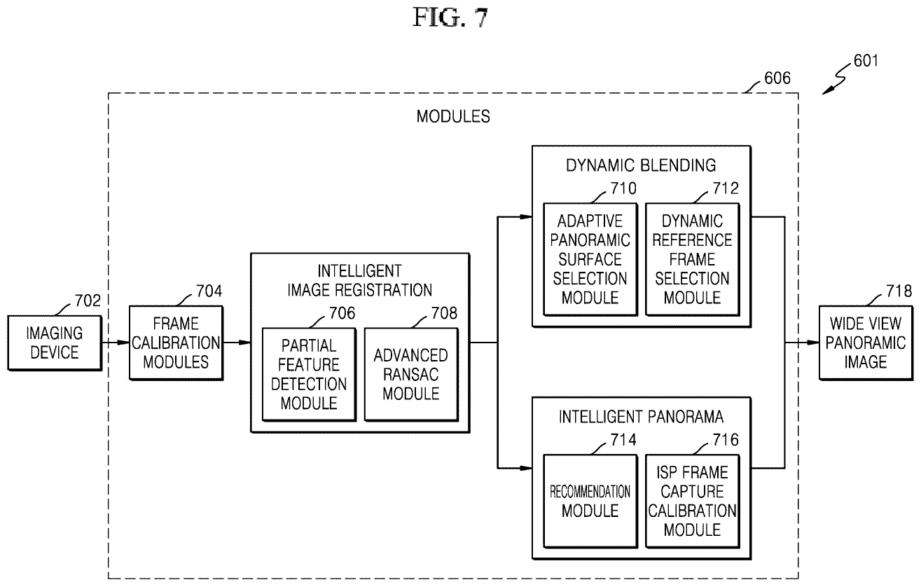

FIG. 6 illustrates a schematic block diagram of an electronic device 601 for generating a panoramic image, according to an embodiment of the present disclosure. In an embodiment, the electronic device 601 may be included within an imaging device associated with a user. In an embodiment, the electronic device 601 may be configured to operate as a standalone device or a system based in a server/cloud architecture communicably coupled to the imaging device. Examples of the imaging device may include, but not limited to, compact cameras, digital cameras, smartphone cameras, mirrorless cameras, video camera, and/or any other image capturing device.

The electronic device 601 may be configured receive and process a plurality of image frames obtained by the imaging device to generate a panoramic image. The electronic device 601 may include a processor/controller 602, an Input/Output (I/O) interface 604, one or more modules 606, a transceiver 608, and a memory 610.

In an embodiment, the processor/controller 602 may be operatively coupled to each of the I/O interface 604, the modules 606, the transceiver 608 and the memory 610. In an embodiment, the processor/controller 602 may include at least one data processor for executing processes in Virtual Storage Area Network. The processor/controller 602 may include specialized processing units such as, integrated system (bus) controllers, memory management control units, floating point units, graphics processing units, digital signal processing units, etc. In one embodiment, the processor/controller 602 may include a central processing unit (CPU), a graphics processing unit (GPU), or both. The processor/controller 602 may be one or more general processors, digital signal processors, application-specific integrated circuits, field-programmable gate arrays, servers, networks, digital circuits, analog circuits, combinations thereof, or other now known or later developed devices for analyzing and processing data. The processor/controller 602 may execute a software program, such as code generated manually (i.e., programmed) to perform the desired operation.

The processor/controller 602 may be disposed in communication with one or more input/output (I/O) devices via the I/O interface 604. The I/O interface 604 may employ communication code-division multiple access (CDMA), high-speed packet access (HSPA+), global system for mobile communications (GSM), long-term evolution (LTE), WiMAX, or the like, etc.

Using the I/O interface 604, the electronic device 601 may communicate with one or more I/O devices, specifically, to the imaging devices used for obtained the plurality of frames. Other examples of the input device may be an antenna, microphone, touch screen, touchpad, storage device, transceiver, video device/source, etc. The output devices may be a printer, fax machine, video display (e.g., cathode ray tube (CRT), liquid crystal display (LCD), light-emitting diode (LED), plasma, Plasma Display Panel (PDP), Organic light-emitting diode display (OLED) or the like), audio speaker, etc.

The processor/controller 602 may be disposed in communication with a communication network via a network interface. In an embodiment, the network interface may be the I/O interface 604. The network interface may connect to the communication network to enable connection of the electronic device 601 with the outside environment and/or device/system. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the electronic device 601 may communicate with other devices. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

In an embodiment, the processor/controller 602 may receive the plurality of frames from the imaging device. In some embodiments where the electronic device 601 is implemented as a standalone entity at a server/cloud architecture, the plurality of the frames may be received from the imaging device via a network. The processor/controller 602 may execute a set of instructions on the received frames to generate the panoramic image. The processor/controller 602 may implement various techniques such as, but not limited to, image processing, data extraction, Artificial Intelligence (AI), Machine Learning (ML), Deep Learning (DL) and so forth to achieve the desired objective.

In some embodiments, the memory 610 may be communicatively coupled to the at least one processor/controller 602. The memory 610 may be configured to store data, instructions executable by the at least one processor/controller 602. In one embodiment, the memory 610 may communicate via a bus within the electronic device 601. The memory 610 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 610 may include a cache or random-access memory for the processor/controller 602. In alternative examples, the memory 610 is separate from the processor/controller 602, such as a cache memory of a processor, the system memory, or other memory. The memory 610 may be an external storage device or database for storing data. The memory 610 may be operable to store instructions executable by the processor/controller 602. The functions, acts or tasks illustrated in the figures or described may be performed by the programmed processor/controller 602 for executing the instructions stored in the memory 610. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

In some embodiments, the modules 606 may be included within the memory 610. The memory 610 may further include a database 612 to store data. The one or more modules 606 may include a set of instructions that may be executed to cause the electronic device 601 to perform any one or more of the methods/processes disclosed herein. The one or more modules 606 may be configured to perform the steps of the present disclosure using the data stored in the database 612, to generate the panoramic image as discussed herein. In an embodiment, each of the one or more modules 606 may be a hardware unit which may be outside the memory 610. Further, the memory 610 may include an operating system 614 for performing one or more tasks of the electronic device 601, as performed by a generic operating system in the communications domain. The transceiver 608 may be configured to receive and/or transmit signals to and from the imaging device associated with the user. In one embodiment, the database 612 may be configured to store the information as required by the one or more modules 606 and the processor/controller 602 to perform one or more functions for generating the panoramic image.

In an embodiment, the I/O interface 604 may enable input and output to and from the electronic device 601 using suitable devices such as, but not limited to, display, keyboard, mouse, touch screen, microphone, speaker and so forth.

Further, the present disclosure contemplates a computer-readable medium that includes instructions or receives and executes instructions responsive to a propagated signal. Further, the instructions may be transmitted or received over the network via a communication port or interface or using a bus (not shown). The communication port or interface may be a part of the processor/controller 602 or may be a separate component. The communication port may be created in software or may be a physical connection in hardware. The communication port may be configured to connect with a network, external media, the display, or any other components in system, or combinations thereof. The connection with the network may be a physical connection, such as a wired Ethernet connection or may be established wirelessly. Likewise, the additional connections with other components of the electronic device 601 may be physical or may be established wirelessly. The network may alternatively be directly connected to the bus. For the sake of brevity, the architecture, and standard operations of the operating system 614, the memory 610, the database 612, the processor/controller 602, the transceiver 608, and the I/O interface 604 are not discussed in detail.

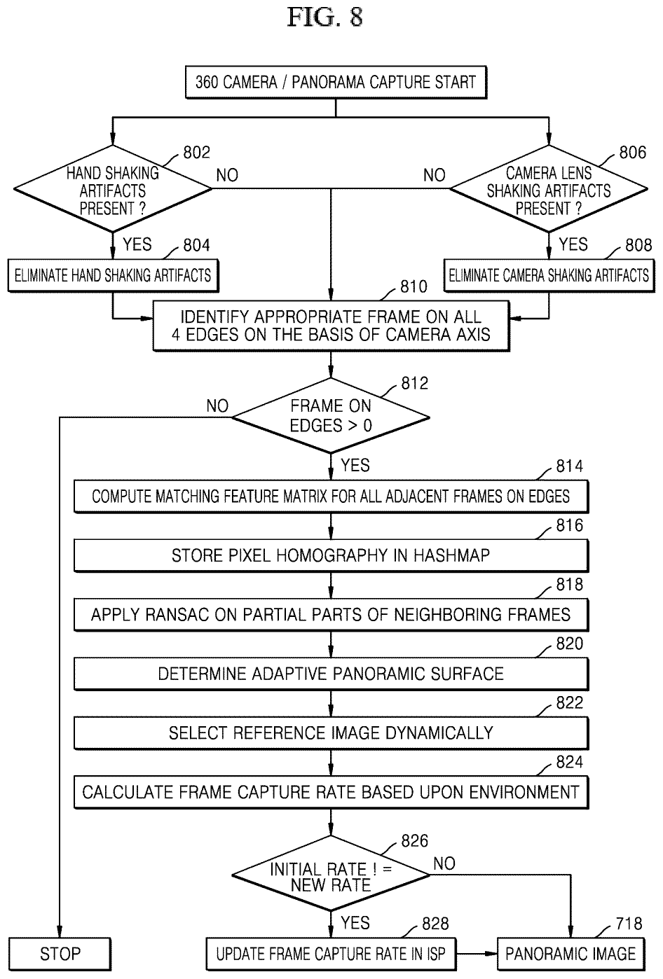

FIG. 7 illustrates a schematic architecture of the electronic device 601 for generating a panoramic image 718 using an imaging device, according to an embodiment of the present disclosure. The panoramic image 718 may refer to a wide-angle view or representation of a physical space.

In an embodiment, the electronic device 601 may be communicably coupled to an imaging device 702. The imaging device 702 may include, but not limited to, compact cameras, digital cameras, smartphone cameras, mirrorless cameras, video camera, and/or any other image capturing device. It may be understood that while FIG. 7 illustrates only one imaging device, there may be multiple such imaging devices to obtain images/frames as discussed throughout the disclosure. The imaging device 702 may be configured to obtain a plurality of frames corresponding to an environment. The environment may refer to a physical space in field of view of the imaging device 702. In an embodiment, the plurality of frames may correspond to a plurality of images obtained by the imaging device 702 from various viewpoints. In an embodiment, a user may move the imaging device 702 in a desired direction to obtain the plurality of frames of the environment.

The electronic device 601 may be configured to receive the obtained plurality of frames as an input to generate the panoramic image 718. The electronic device 601 may include a frame calibration module 704, a partial feature detection module 706, an advanced Random Sample Consensus (RANSAC) module 708 (interchangeably referred to as “the RANSAC module 708”), an adaptive panoramic surface selection module 710, a dynamic reference frame selection module 712, a recommendation module 714, and an Image Signal Processing (ISP) frame capture calibration module 716.

The electronic device 601 may be configured to receive the plurality of frames obtained by the imaging device 702. In an embodiment, as a first step, the frame calibration module 704 may receive the plurality of frames from the imaging device 702. The frame calibration module 704 may be configured to remove artifacts in the plurality of frames which may be caused due to a user-hand movement and/or a camera movement of the imaging device 702. In an embodiment, the frame calibration module 704 may be configured to receive inertial sensor data of the imaging device 702 for each of the plurality of frames. In an embodiment, the imaging device 702 may include one or more inertial sensors (not shown) to generate the inertial sensor data. The one or more inertial sensors may include, but not limited to, a gyroscope, a compass, an accelerometer and so forth. The inertial sensor data may include information such as, but not limited to, orientation information, directional information, speed, and gravity related information.

The frame calibration module 704 may be configured to generate one or more rotational parameters and one or more translation parameters based on the inertial sensor data. Specifically, the frame calibration module 704 may be configured to pre-process each of the plurality of frames based on the one or more rotational parameters and the one or more translation parameters to remove the artifacts from the plurality of frames. In an embodiment, the one or more rotation parameters may be an amount of rotation of a frame required to be performed to remove the radial and/or tangential distortions from the frame. Further, the one or more translation parameters may be an amount of correction to be performed at a frame to have clear and sharp pixels of the frame. The frame calibration module 704 may be configured to pass the pre-processed frames to an intelligent image registration block including the partial feature detection module 706 and the advanced RANSAC module 708. In an embodiment, the frame calibration module 704 may be implemented by any suitable hardware and/or software, or a combination thereof.

The partial feature detection module 706 may be configured to perform feature detection on each of the plurality of frames using one or more parameters associated with each of the plurality frames. In an embodiment, the partial feature detection module 706 may be configured to perform feature detection on partial regions of the frames. In an embodiment, the partial feature detection module 706 may be configured to determine features corresponding to each of the plurality of frames. Initially, the partial feature detection module 706 may be configured to determine a first features and a second features corresponding to a first frame and a second frame, of the plurality of frames, respectively. The first frame may be an image frame which is initially obtained by the imaging device 702 and the second frame may be an image frame which is secondly obtained by the imaging device 702. Thereafter, the partial feature detection module 706 may be configured to determine a first partial region and a second partial region corresponding to the first frame and the second frame, respectively, based on a first comparison of the first features and the second features.

Further, for each next frame after the second frame, the partial feature detection module 706 may be configured to identify a next partial region of the next frame based on at least one of partial regions of one or more previously obtained frames and the inertial sensor data. The next frame may be an image frame which is sequentially obtained by imaging device 702 after the second frame is obtained. For instance, the partial feature detection module 706 may be configured to identify a partial region of a third frame, based on partial regions identified for the first frame and the second frame. Similarly, to identify a partial region corresponding to a fourth frame, the partial feature detection module 706 may be configured to use the partial region information corresponding to at least one of the first frame, the second frame and the third frame. Similarly, the partial feature detection module 706 may be configured to identify a partial region corresponding to each of the plurality of frames. Further, based on partial region identified for each of the next frame after the second frame, the partial feature detection module 706 may be configured to determine next features corresponding to the next frame based on the identified next partial region corresponding to the next frame. Further, in some embodiments, the partial feature detection module 706 may be configured to update the next partial region for the next frame based on the second comparison of the next features and features corresponding to the previously obtained frame. The partial feature detection module 706 may only process partial regions of the next frames after the second frame. Thus, the partial processing may significantly reduce computational resource and time.

Further, the partial feature detection module 706 may be configured to perform the feature detection to identify a correspondence between at least two adjacent frames of the plurality of frames. Specifically, the partial feature detection module 706 may be configured to generate a similarity between each frame of the plurality of frames with respect to at least one adjacent frame based on determined features corresponding to each frame.

In an embodiment, the partial feature detection module 706 may be configured to identify inliers and outliers corresponding to each frame based on a comparison of the features of the plurality of frames. The inliers may be a similar feature in two adjacent frames. Further, the outliers may be a distinctive feature in the two adjacent frames. For instance, in overlapping regions of two adjacent features that may be easily identified and mapped may be referred to as inliers. The features which cannot be mapped and identified may be referred to as outliers. In an embodiment, the partial feature detection module 706 may be configured to determine at least one of a rate of change of inliers, a rate of change of outliers, a distance of a farthest inlier from a frame edge of the first frame, a distance of a farthest inlier from a frame edge of the second frame, a distance of a farthest outlier from the frame edge of the first frame, and a distance of a farthest outlier from the frame edge of the second frame based on the first comparison of the first features and the second features, and the inertial sensor data. In an embodiment, the partial feature detection module 706 may be configured to determine the first partial region and the second partial region corresponding to the first frame and the second frame based on the first features and the second features, and at least one of the rate of change of inliers, the rate of change of outliers, the distance of the farthest inlier from the frame edge of the first frame, the distance of the farthest inlier from the frame edge of the second frame, the distance of the farthest outlier from the frame edge of the first frame, and the distance of the farthest outlier from the frame edge of the second frame.

Similarly, the partial feature detection module 706 may also be configured to compare the next features corresponding to the next frame and the features corresponding to the previously obtained frame to determine at least one of a rate of change of inliers, a rate of change of outliers, a distance of farthest inlier from a frame edge of the previously obtained frame, a distance of farthest inlier from a frame edge of the next frame, a distance of farthest outlier from the frame edge of the previously obtained frame, and a distance of farthest outlier from the frame edge of the next frame based the second comparison of the next features corresponding to the next frame and the features corresponding to the previously obtained frame, and the inertial sensor data. In an embodiment, the rate of change of inliers for a frame may defined as a number of inliers with respect to a total number of inliers and outliers corresponding to the frame. Similarly, a rate of change of outliers for a frame may be defined as a number of outliers with respect to a total number of inliers and outliers corresponding to the frame. In an embodiment, the partial feature detection module 706 may be configured to update the next partial region for the next frame based on the next features and features corresponding to the previously obtained frame, and at least one of the rate of change of inliers, the rate of change of outliers, the distance of farthest inlier from the frame edge of the previously obtained frame, the distance of farthest inlier from the frame edge of the next frame, the distance of farthest outlier from the frame edge of the previously obtained frame, and the distance of farthest outlier from the frame edge of the next frame.

Further, the partial feature detection module 706 may be configured to determine the similarity between at least two adjacent frames based on an identified relationship between inliers and outliers corresponding to each of the at least two adjacent frames. In an embodiment, the identified relationship may be defined by one or more above-mentioned parameters such as, a rate of change of inliers, a rate of change of outliers, a distance of a farthest inlier from a frame edge, a distance of a farthest outlier from the frame edge and so forth. Therefore, the similarity between a frame respect to the at least one adjacent frame indicates a relationship between the inliers and the outliers identified based on a third comparison of the frame and the at least one adjacent frame. In an embodiment, the identified similarity between each pair of adjacent frames may be used to generate the panoramic image 718.

In an embodiment, the partial feature detection module 706 may be operatively coupled to the advanced RANSAC module 708 to perform one or more operation explained above. In an embodiment, the advanced RANSAC module 708 may be configured to detect adjacent and/or neighbor frames based on the inertial sensor data. In some embodiments, the advanced RANSAC module 708 may be configured to identify partial region and a direction of feature detection. Further, the advanced RANSAC module 708 may be configured to identify the similarity required to generate the panoramic image. The advanced RANSAC module 708 may be configured to update partial region and a direction for each next frame to be identified. Further, the electronic device 601 may utilize the direction identified by the advanced RANSAC module 708 to stitch all the plurality of frames and generate the panoramic image 718.

In an embodiment, the plurality of frames, corresponding information related to inliers and outliers, and the identified similarity between the adjacent frames may be passed to a dynamic blending block and/or an intelligent panorama block. In an embodiment, the inertial sensor data may also be passed to the dynamic blending block and/or the intelligent panorama block.

The dynamic blending block may include the adaptive panoramic surface selection module 710 and the dynamic reference frame selection module 712. The adaptive panoramic surface selection module 710 may be configured to adaptively determine a final panoramic surface for the panoramic image 718 based on the inertial sensor data and one or more characteristics associated with each of the plurality of frames. In an embodiment, the adaptive panoramic surface selection module 710 may be configured to determine one or more device related parameters of the imaging device 702 based on the inertial sensor data. The one or more device related parameters may include information such as, but not limited to, a speed and a direction of motion of the imaging device 702 while obtained the plurality of frames. Further, the adaptive panoramic surface selection module 710 may be configured to determine one or more characteristics of the plurality of frames based on the one or more device related parameters. The one or more characteristics corresponding to each of the plurality of frames may include, but not limited to, 2-D frame coordinates of a frame, a distance between two consecutive frames, and an angle of a last obtained frame from the plurality of frames. Thereafter, the adaptive panoramic surface selection module 710 may be configured to identify the adaptive panoramic surface for the generation of the panoramic image based on the one or more device related parameters and the one or more characteristics of the plurality of frames. The adaptive panoramic surface may be a surface type on which the panoramic image should be generated. Examples of the adaptive panoramic surface may include, but not limited to, linear, circular, rectangular, or spherical. In an embodiment, the adaptive panoramic surface selection module 710 may be configured to implement technologies such as, but not limited to, Artificial Intelligence (AI), Machine Learning (ML), Deep Learning (DL) and so forth. In an embodiment, the adaptive panoramic surface selection module 710 may be configured to pass all the identified device related parameters and the one or more characteristics of the plurality of frames to a ML model to obtain the adaptive panoramic surface. The adaptive panoramic surface selection module 710 may be implemented by any suitable hardware, software and/or a combination thereof.

In an embodiment, the dynamic reference frame selection module 712 may be configured to receive all the plurality of frames, the inertial sensor data, one or more device related parameters, one or more characteristics of the plurality of frames, information relating to inliers and outliers of the plurality of frames and/or the identified adaptive panoramic surface to identify a reference frame. In an embodiment, the dynamic reference frame selection module 712 may be configured to identify the reference frame from the plurality of frames based at least on one of the speed of the imaging device while obtained the frame, a distance between the reference frame and one or more neighboring frames, and the direction of motion of the imaging device while obtained the frame. In some embodiments, the dynamic reference frame selection module 712 may be configured to identify a final panoramic surface for the generation of the panoramic image 718 based on the identified reference frame and the adaptive panoramic surface. In an embodiment, the adaptive panoramic surface selection module 710 may be configured to implement technologies such as, but not limited to, Artificial Intelligence (AI), Machine Learning (ML), Deep Learning (DL) and so forth. In an embodiment, the dynamic reference frame selection module 712 may be configured to pass all the identified device related parameters and the one or more characteristics of the plurality of frames to a ML model to obtain the reference frame and/or the final panoramic surface. Further, the dynamic reference frame selection module 712 may be implemented by any suitable hardware, software and/or a combination thereof.

The intelligent panorama block may be configured to calibrate frame capture rate and provide a set of recommendations. In an embodiment, the recommendation module 714 may be configured to receive all the plurality of frames and the inertial sensor data to generate one or more recommendations for the user. The recommendation module 714 may be configured to process each of the plurality of frames in view of the inertial sensor data while obtaining the plurality of frames. In some embodiments, the recommendation module 714 may process the frames to identify one or more artifacts such as, but not limited to, wrong frame alignment, wrong position of the imaging device and so forth, during the capture. Therefore, to prevent such artifacts, the recommendation module 714 may be configured to generate one or more recommendations such as, a desired rotation of the imaging device, a desired distance, a desired angle of capture and so forth. Therefore recommendations enhance user experience and improves overall quality of the final panoramic image 718.

The ISP frame capture calibration module 716 may be configured to calibrate a frame capture rate. The ISP frame capture calibration module 716 may be configured to receive a speed of imaging device, an overlapping region of adjacent frames and a speed of an object in the environment, to determine a time to obtain a next frame. Further, the ISP frame capture calibration module 716 may also be configured to determine a number of frames to be obtained to obtain an accurate panoramic image. Thus, the ISP frame capture calibration module 716 may be configured to enhance the overall speed to the generate the final panoramic image 718.

The final panoramic image 718 may be the output of the electronic device 601. The final panoramic image 718 may be a stitched image including all the plurality of frames, as required. Further, the final panoramic image may provide a larger field of view as compared to each of the individual frame of the plurality of frames.

At least one of the plurality of modules 704-716 may be implemented through an AI model. A function associated with AI may be performed through the non-volatile memory, the volatile memory, and the processor.

The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that, by applying a learning technique to a plurality of learning data, a predefined operating rule or AI model of a desired characteristic is made. The learning may be performed in a device itself in which AI according to an embodiment is performed, and/o may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

According to the disclosure, in an electronic device for generating a panoramic image, the electronic device may use an artificial intelligence model to recommend/execute the plurality of instructions by using sensor data. The processor may perform a pre-processing operation on the data to convert into a form appropriate for use as an input for the artificial intelligence model. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of co

Reasoning prediction is a technique of logically reasoning and predicting by determining information and includes, e.g., knowledge-based reasoning, optimization prediction, preference-based planning, or recommendation.

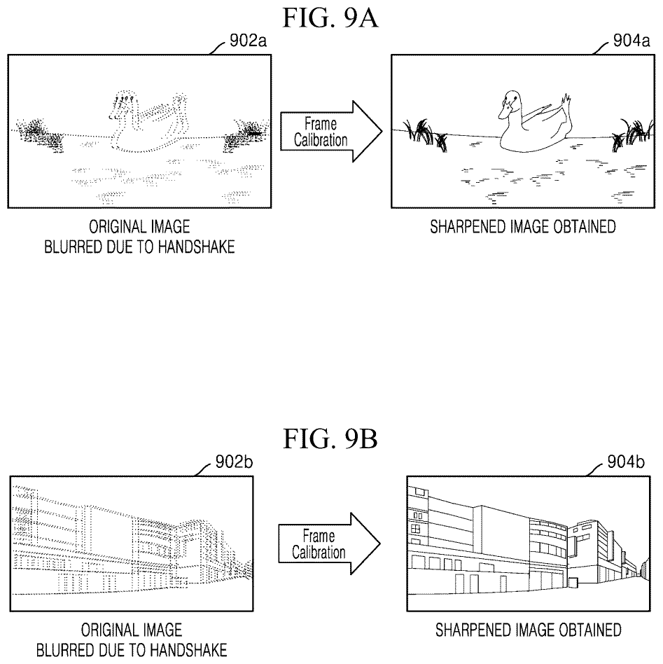

FIG. 8 illustrates an process flow depicting a method 800 for generating the panoramic image 718, according to an embodiment of the present disclosure. The method 800 may be performed by the electronic device 601 in conjunction with the imaging device 702. The method 800 may be performed on the plurality of frames obtained by the imaging device 702.

At operation 802, the method 800 includes determining whether any hand shaking artifacts are present in the plurality of frames. The hand shaking artifacts may be caused due to improper hand movement of the user while obtained the plurality of frames. Upon determining presence of hand shaking artifacts, the method 800 may perform the operation 804 to remove such artifacts. Specifically, at operation 804, the method 800 includes eliminating the hand shaking artifacts from the frames. In an embodiment, the frame calibration module 704 may be configured to remove the hand shaking artifacts based on the one or more rotational parameters and one or more translation parameters, which are determined based on the inertial sensor data, as discussed above in reference to FIG. 7.

At operation 806, the method 800 includes determining whether any camera lens shaking artifacts are present in the frames. The camera lens shaking artifacts may be caused due to unwanted displacement of a camera sensor of the imaging device 702 due to at least one of internal factors and/or external factors. The internal factors may include, but not limited to, a malfunction of the camera sensor of the imaging device 702. The external factors may include, but not limited to, displacement of the imaging device 702 due to environmental conditions such as, but not limited to, an improper surface for the imaging device while obtained the frames of images. Upon determining camera lens shaking artifacts the method 800 may perform operation 808. Specifically, at operation 808, the method 800 includes eliminating the camera lens shaking from the frames. In an embodiment, the frame calibration module 704 may remove the camera lens shaking artifacts from the frames based on the one or more rotational parameters and one or more translation parameters, which are determined based on the inertial sensor data, as discussed above in reference to FIG. 7.

Further, the method 800 includes processing the frames after removing the artifacts from the frames. At operation 810, the method 800 includes identifying adjacent frames corresponding to each side of every frame of the plurality of frames. In an embodiment, the adjacent frames may be referred to as appropriate frames and may be identified based on a camera axis during obtaining the frames.

At operation 812, the method 800 includes determining if there is any adjacent frame on any of the edge of a first frame. If there is no adjacent frame, the method 800 moves to end the process of generating the panoramic image. In case there is any adjacent frame, the method 800 moves to operation 814. At operation 814, the method 800 includes computing matching features matrix for each adjacent frame on the edges of every frame. Specifically, the matching features matrix may be referred to as the correspondence between inliers and outliers of the adjacent frames, as discussed above.

At operation 816, the method 800 includes storing a pixel homography in HashMap's. The pixel homography may be determined based on the matching feature matrix. The HashMap may be stored in a memory to use for further processing of the frames and generate the panoramic image 718.

At operation 818, the method 800 includes applying RANSAC technique on partial parts and/or regions of adjacent and/or neighboring frames. The RANSAC technique may be configured to use the correspondence of the inliers and the outliers to identify pixel homography of next frames. The RANSAC technique may be configured to identify partial regions of all the neighboring frames corresponding to each frame of the plurality of frames. Further, the RANSAC technique may also be configured to identify the similarity between the neighboring frames in the identified partial regions.

At operation 820, the method 800 includes determining an adaptive panoramic surface for the generation of the panoramic image 718. In an embodiment, the adaptive panoramic surface selection module 710 may determine the adaptive panoramic surface based on parameters associated with the user and the imaging device 702. The parameters to determine the adaptive panoramic surface may include, but not limited to, the frames and corresponding position coordinates, a distance matrix indicating a distance between the frames, an angle of each frame, a direction of the frames, and a field of view.

At operation 822, the method 800 includes dynamically selecting a reference frame for the generation of the panoramic image 718. In an embodiment, the dynamic reference frame selection module 712 may be configured to dynamically select the reference frame from the plurality of frames based on parameters associated with the imaging device 702, the user, the frames, and the environment. The parameters to select the reference frame may include, the frames, a speed of the imaging device 702 while obtained the frames, a number of sharp edges in each frame, a rate of change of inliers in each frame, and the identified adaptive panoramic surface.

At operation 824, the method 800 includes calculating a frame capture rate based upon the environment. In an embodiment, the frame capture rate may be identified based on a speed of the imaging device 702 while obtained the frames, overlapping regions between neighboring frames, a speed of the object in the frames.

At operation 826, the method 800 includes comparing an initial frame capture rate to the identified new frame capture rate. The initial frame capture rate may refer to a rate of obtaining the plurality of frames. In case there is a different between the initial frame capture rate and the new frame capture rate, the method 800 moves to operation 828. At operation 828, the method 800 includes updating the frame capture rate with the identified new frame capture rate to generate the panoramic image 718, effectively and efficiently.

Embodiments as discussed above are exemplary in nature and the method 800 may include any additional step or operation or omit any of above-mentioned steps or operations to perform the desired objective of the present disclosure. Further, the steps of the method 800 may be performed in any suitably order in order to achieve the desired advantages.

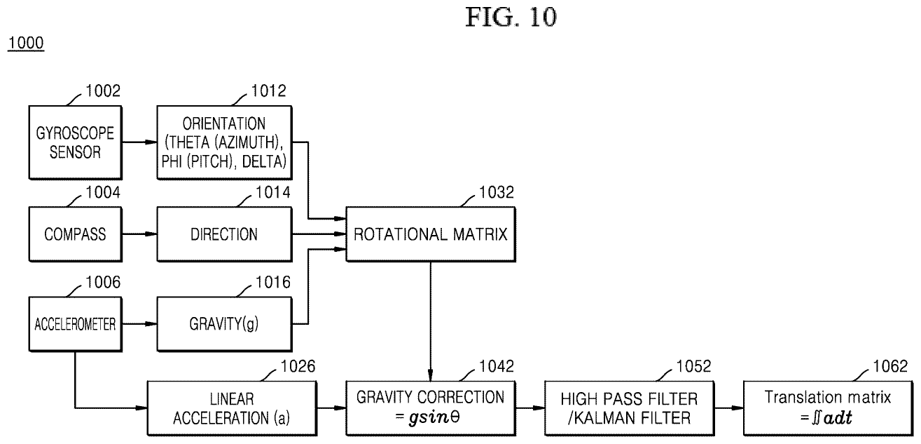

FIGS. 9A and 9B illustrate elimination of artifacts from image frames by the frame calibration module 704, according to an embodiment of the present disclosure. In an embodiment, the frames 902a and 902b includes artifacts i.e., blurriness due to handshake movement of the user. The frame calibration module 704 may remove such artifacts to generate sharpened image frames 904a, 904b, respectively. As illustrated, the frames 904a and 904b are clear and sharp, as compared to the frames 902a and 902b, respectively. Thus, the frame calibration module 704 may pre-process the frames to generate the panoramic image 718, effectively and accurately. In an embodiment, the frame calibration module 704 may remove radial and tangential distortions to eliminate the artifacts from the frames. Further, the frame calibration module may perform radial and tangential coefficient calculation to identify radial distortion parameters and tangential distortion parameters to eliminate the artifacts from the frame. The radial and tangential coefficient calculation may be defined by following equations:

$$[ \begin{matrix}{X}_{c} \\ {Y}_{c} \\ {Z}_{c}\end{matrix} ] = [ R \vert T ] [ \begin{matrix}{X}_{w} \\ {Y}_{w} \\ {Z}_{w}\end{matrix} ]$$

$${x}^{′} = \frac{{X}_{c}}{{Z}_{c}}$$

$${y}^{′} = {y}_{c} / {Z}_{c}$$

$$γ = ( 1 + {K}_{1} {r}^{2} + {K}_{2} {r}^{4} + {K}_{3} {r}^{6} ) / ( 1 + {K}_{4} {r}^{2} + {K}_{5} {r}^{4} + {K}_{6} {r}^{6} )$$

$${r}^{2} = {x}^{′2} + {y}^{′2}$$

$${x}^{″} = {x}^{′} ( γ ) + 2 {P}_{1} {x}^{′} {y}^{′} + {P}_{2} ( {r}^{2} + 2 {x}^{′2} )$$

$${y}^{″} = {y}^{′} ( γ ) + {P}_{1} ( {r}^{2} + 2 {y}^{′2} ) + 2 {P}_{2} {x}^{′} {y}^{′}$$

$$s * [ \begin{matrix}{x}_{img} \\ {y}_{img} \\ 1\end{matrix} ] = [ \begin{matrix}- 1 / {m}_{x} & 0 & {c}_{x} \\ 0 & - 1 / {m}_{y} & {c}_{y} \\ 0 & 0 & 1\end{matrix} ] [ \begin{matrix}f & 0 & 0 \\ 0 & f & 0 \\ 0 & 0 & 1\end{matrix} ] [ \begin{matrix}{x}^{″} \\ {y}^{″} \\ 1\end{matrix} ]$$

Wherein X, Y and Z are images coordinates used to identify radial and tangential distortion. (X_{c}, Y_{c}, Z_{c}) denotes a point in 3-dimensional space. (x′, y′) denotes an undistorted point of normalized image. (x″, y″) denotes a distorted point of normalized image. r denotes a distance from principal point to (x′, y′). K₁, K₂, K₃, K₄, K₅ and K₆ denote radial coefficient. P₁ and P₂ denote tangential coefficient. mₓ, m_{y}, mₓ, c_{y} and f denote camera intrinsic parameters

In an embodiment, the frame calibration module 704 may be configured to determine one or more rotational parameters and one or more translation parameters to remove the radial and tangential distortions from the frames. The one or more rotational parameters and the one or more translation parameters may be represented in form of matrices defined as, rotational matrix and translation matrix, respectively.

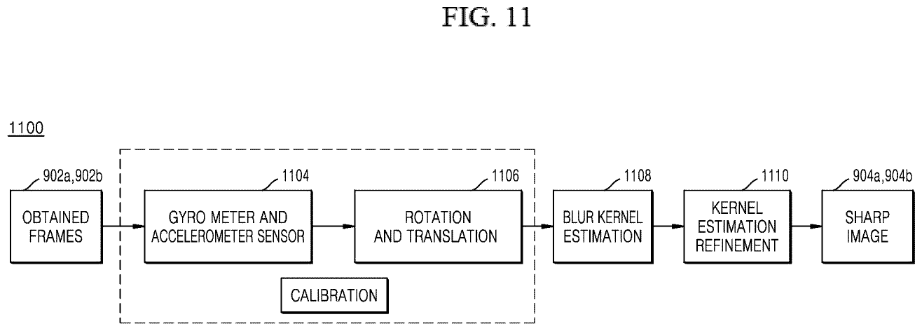

FIG. 10 illustrates a schematic process flow 1000 for generating the rotational and translation matrices, according to an embodiment of the present disclosure. The frame calibration module 704 may be configured to receive the inertial sensor data to generate the rotational and translation matrices. In an embodiment, the frame calibration module 704 may be configured to receive one or more inputs from a gyroscope sensor 1002 to determine an orientation 1012 of the imaging device 702, one or more inputs from a compass 1004 to determine a direction 1014 of the imaging device 702 and one or more inputs from an accelerometer 1006 to determine gravity (g) 1016 and a linear acceleration (a) 1026. The frame calibration module 704 may be configured to use the determined orientation 1012, the direction 1014, and the gravity (g) 1016 to determine the rotational matrix 1032. Further, the frame calibration module 704 may be configured to use the linear acceleration 1026 and the rotational matrix 1032 to determine the translational matrix 1062. In an embodiment, the frame calibration module 704 may be configured to determine a gravity correction 1042 which is then passed to high pass filter and/or Kalman filter 1052 to generate the translation matrix 1062.

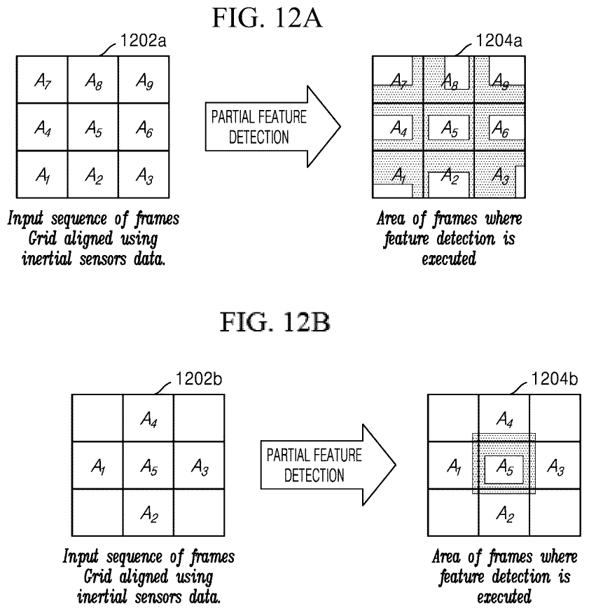

FIG. 11 illustrates of a schematic workflow 1100 of the frame calibration module 704, according to an embodiment of the present disclosure. Initially, the obtained frames 902a, 902b may be passed to the frame calibration module 704 as inputs. The frame calibration module 704 may also receive inputs from the gyro meter and accelerometer sensor 1104 to generate the rotational matrix 1032 and translation matrix 1062 Thereafter, the frame calibration module 704 may be configured to estimate 1108 a blur kernel by following equation:

$${k}^{( r )} = {\sum }_{θ} {μ}_{θ} {b}_{θ}^{( r \}} , where {b}_{θ} = C ( {R}_{θ} + \frac{1}{d} {T}_{θ} [ 0 , 0 , 1 ] ) {C}^{- 1}$$

k^{(r)} denotes the blur kernel. μ_{θ} denotes the coefficients of the kernel bases, which are determined by the rotational matrix 1032 and translation matrix 1062. b_{θ}^{(r)}

Thereafter, the frame calibration module 704 may refine 1110 the estimated kernel to remove unwanted errors which may be caused due to noise, scene depth, calibration. In an embodiment, the frame calibration module 704 may refine the estimated kernel based on the inputs received from the gyro meter and accelerometer sensor. Further, refinement of the kernel 1110 may be defined by following equation:

$$B = {\sum }_{r} {k}^{( r )} * ( {ω}^{( r )} ⊙ I ) + n .$$

Here, r is a region index, and ω^{(r)} is an image of weights with the same dimensions as the sharp image I, such that the pixels in region r can be expressed as ω^{(r)}⊙I (pixel wise product.). The sharp image I may be a deblurred image.

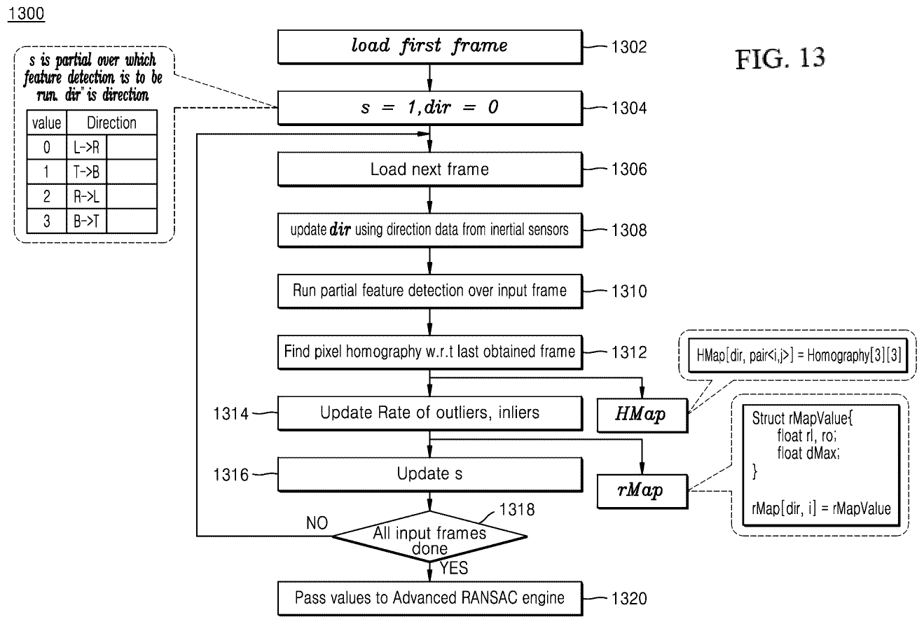

Further, the frame calibration module 704 may be configured to perform non-bind deconvolution on the refined kernel to obtain the sharp images 904a, 904b. In an embodiment, the non-bind deconvolution may be performed by point-by-point division of the two signals in a Fourier domain. In an embodiment, the deconvolution process may be defined as:

$$B ( x , y ) = I ( x , y ) * K ( x , y )$$

$$B ( u , v ) = ℱ \{ B ( x , y ) \} = I ( u , v ) , K ( u , v )$$

$$I ( u , v ) = \frac{B ( u , v )}{K ( u , v )}$$

$$I ( x , y ) = {ℱ}^{- 1} \{ I ( u , v ) \}$$

[symbol] {.} denotes Fourier transform operator. [symbol] ⁻¹ {.} denotes inverse Fourier transform operator. B(u, v) may be a result of the Fourier transform of B(x, y). I(u, v) may be a result of the Fourier transform of I(x, y). K(u, v) may be a result of the Fourier transform of K(x, y). FIGS. 12A and 12B illustrate partial region identification by the partial feature detection module 706, according to an embodiment of the present disclosure. FIG. 12A illustrates a plurality of frames A1-A9, aligned in a grid 1202a. In an embodiment, the partial region detection module 706 may be configured to align the plurality of frames in the grid 1202a based on the inertial sensor data. Specifically, the partial region detection module 706 may be configured identify a direction of movement of the imaging device 702 while obtained the frame to determine the alignment of the frames in the grid 1202a. Further, the partial region detection module 706 may be configured identify partial region corresponding each frame as highlighted with shaded portion. The partial region detection module 706 may perform one or more steps, as already explained in reference to FIG. 7, to determine the partial regions i.e., area of frames where feature detection is to be performed. However, the description of the steps to identify the partial regions have been omitted in reference to FIGS. 12A and 12B for the sake of brevity. Also, similar to FIG. 12A, the partial feature detection module 706 may be configured to identify partial regions for the frames A1-A5, aligned in the grid 1202b, as illustrated in FIG. 12B. Further, the partial feature detection module 706 may be configured to perform the feature detection on the identified partial regions to establish a correspondence between adjacent frames. Therefore, the identified partial regions significantly reduce inputs for feature detectors.

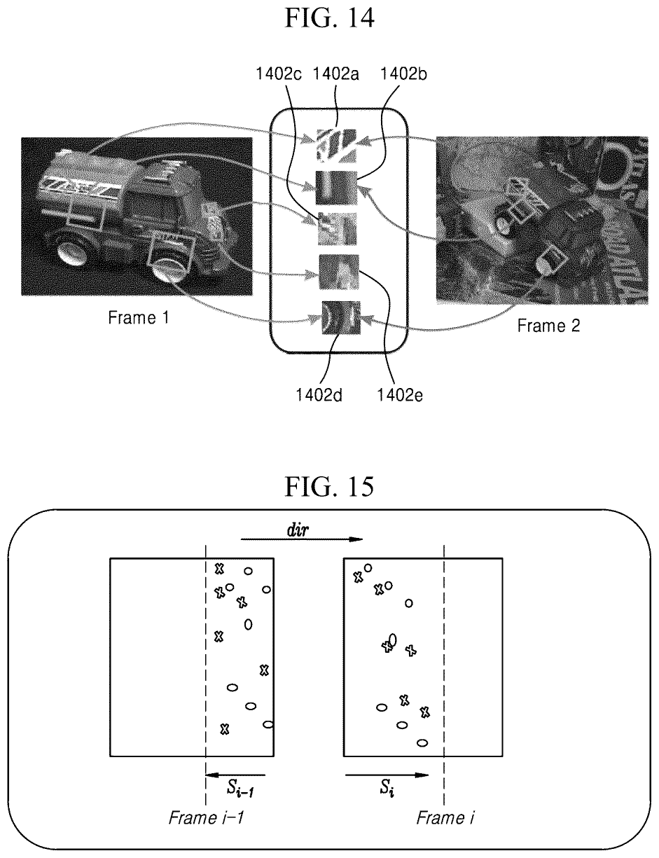

FIG. 13 illustrates a process flow of a method 1300 performed by the partial feature detection module 706, according to an embodiment of the present disclosure.

At operation 1302, the method 1300 including loading a first obtained frame of the plurality of frames. Further, at operation 1304, the method 1300 includes initializing “s and “dir”. “s” denotes a partial region and initial value of “s” is 1 for first frame. “dir” denotes a direction and initial value of “dir” is 0 for first frame. The values of s may be defined within a range of 0-1. Further, the values of dir may be defined within a range of 0-3. Further, the value of dir and the corresponding direction may be as defined by below Table 1:

TABLE 1

| Value | Direction |
|---|---|
| 0 | Left->Right |
| 1 | Top ->Bottom |
| 2 | Right ->Left |
| 3 | Bottom->Top |

At operation 1306, the method 1300 includes loading a next frame. Similarly, all the frames may be loaded. Further, at operation 1308, the method 1300 includes updating a value of dir based on the inertial sensor data. The partial feature detection module 706 may be configured to identify a direction data from the inertial sensor data to update the dir for each next frame.

At operation 1310, the method 1300 includes performing partial feature detection over input frames. In an embodiment, the partial feature detection module 706 may be configured to identify partial regions of the each of the frame after first frame and perform feature detection on the partial regions of the frames.

Further, at operation 1312, the method 1300 includes determining pixel homography of a frame with respect to a last obtained frame. The partial feature detection module 706 may be configured to identify the pixel homography based on the feature identified from the partial regions of the frame. The method 1300 also include generating the HMap based on determined pixel homography. In an embodiment, HMap may include pixel change information associated with frames with respect to a direction of movement of the imaging device while obtained the frames. In an embodiment, the partial feature detection module 706 may be configured to identify inliers, outliers, and corresponding rate of change of the inliers and outlies from the identified features of the frames, to determine the pixel homography between the frames.

At operation 1314, the method 1300 includes updating the rate of change of outliers and inliers based on the identified pixel homography. Moreover, the method 1300 includes generating a rMap based on updated rate of change of outliers and inliers. The rMap may include information of the rate of change of inliers and outliers with respect to the direction of the movement of the imaging device while obtained the frames. Further, at operation 1316, the method 1300 includes updating a value of s after each frame. The method 1300 may include performing operations 1306-1316 for each of the plurality of frames.

At operation 1318, the method 1300 may include determining processing of each of the plurality of frames. Once all the frames are completed, the method 1300 includes passing the values corresponding to each of the plurality of frames to the advanced RANSAC module 708. The values corresponding to each of the plurality of frames may include a value of s and dir corresponding to each frame. Further, the values corresponding to each of the plurality of frames may also include a rate of change of inliers and outliers.

While the above discussed operations in FIG. 13 are shown and described in a particular sequence, the operations may occur in variations to the sequence in accordance with various embodiments.

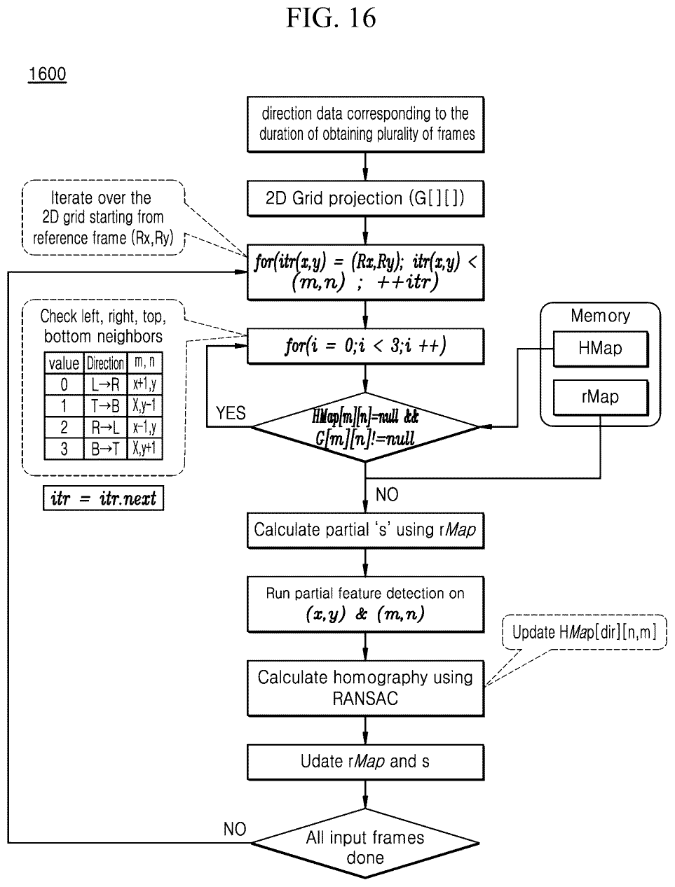

FIG. 14 illustrates an embodiment of identification of inliers and outliers in two frames, in accordance with the present disclosure. As illustrated, five features i.e., 1402a-1402e have been identified in frame 1, whereas only three features i.e., 1402a, 1402b and 1402e have been identified in frame 2. Accordingly, the features 1402a, 1402b and 1402e may be defined as inliers and features 1402c and 1402d may be defined as outliers.

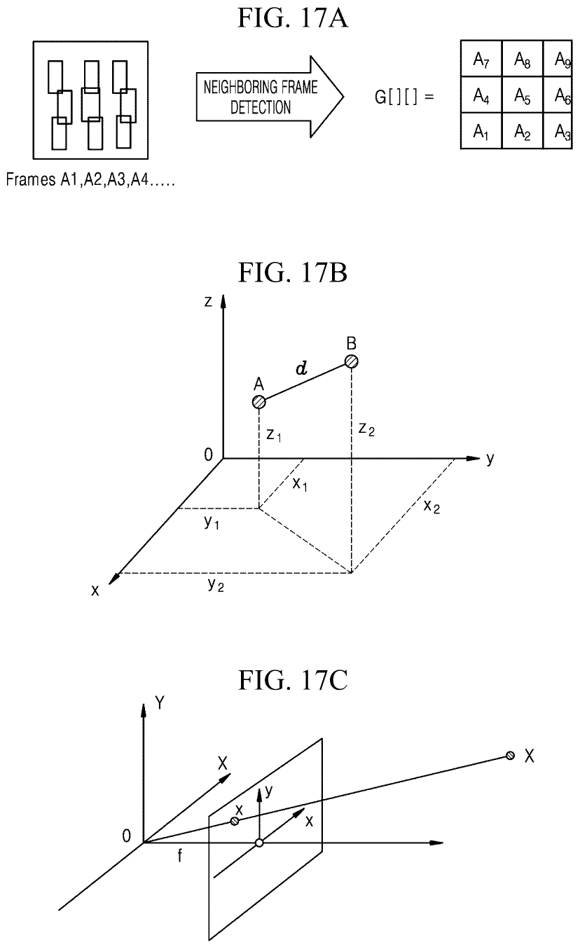

FIG. 15 illustrates partial feature registration, in accordance with an embodiment of the present disclosure. FIG. 15 illustrates two adjacent frames Si−1 and Si. Further, “o” may represent inliers of the frames and “x” may represent outliers of the frames. Further, a rate of changes of inliers may be defined by the equation:

$$change in inliers ( δ {I}_{i} ) = \frac{{( {N}_{I} )}_{i}}{{( {N}_{I} )}_{i} + {( {N}_{o} )}_{i}}$$

Where, N_{I} may represent number of inliers and Nₒ may represent number of outliers.

$$Rate of change in inliers in dir ( rI ) = \frac{δ {I}_{i} - δ {I}_{i - f}}{f}$$

Further, a rate of changes of inliers in a direction may be defined by the equation:

$$Farthest inlier distance ( {d}_{x} ) = \frac{1}{K} * {\sum }_{i ϵ k} {d}_{i}$$

Where f may represent the frame in the direction which has been considered.

Moreover, a farthest inlier distance may be defined by the Equation:

$$Farthest inlier distance ( {d}_{x} ) = \frac{1}{K} * {\sum }_{i ϵ k} {d}_{i}$$

Also, the partial region estimation may be defined by the equation:

$$partial estimate {S}_{i} = βδ {I}_{i} + ( 1 - β ) \{ α {S}_{i - 1} + ( 1 - α ) + {S}_{i - 2} + {( 1 - α )}^{2} * {S}_{i - 3} … \}$$

$$where α ( smoothening ) and β are hyper parameters . 0 < α , β < 1$$

In an embodiment, similar equations may be defined for the outliers.

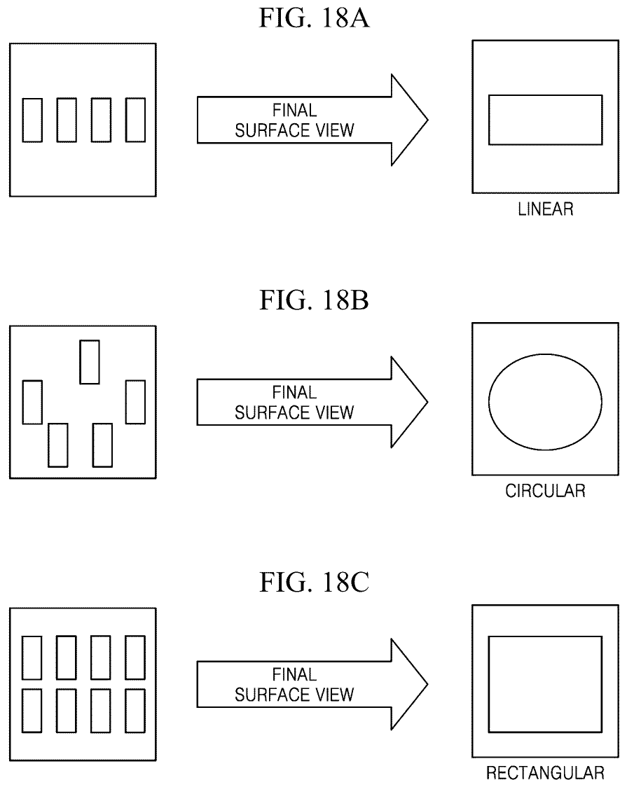

FIG. 16 illustrates a process flow of a method 1600 performed by the advanced RANSAC module 708, according to an embodiment of the present disclosure.

At operation 1602, the method 1600 includes receiving direction data corresponding to the duration of obtained plurality of frames by the imaging device 702. In an embodiment, the advanced RANSAC module 708 may generate the direction data based on the inertial sensor data received from the imaging device 702.

At operation 1604, the method 1600 includes generating a 2-Dimension (2D) grid projection of the plurality of frames based on the direction data. In an embodiment, the advanced RANSAC module 708 may be configured to align the plurality of frames in a 2D grid which may be referred to as 2D grid projection of the frames. By aligning the plurality of frames in the 2D grid, the advanced RANSAC module 708 may assign a position coordinate for each frame of the plurality of frames.

At operation 1606, the method 1600 including identifying a reference frame and initializing an iteration to process the plurality of frames, taking the reference frame as the initial frame.

At operations 1608 and 1610, the method 1600 includes identifying neighboring and/or adjacent frames corresponding to each of the plurality of frames in every direction. The method 1600 includes utilizing the HMap and rMap generated by the partial feature detection module 706 to identify the neighboring frames and corresponding similarity between the features of the frames.

At operation 1612, the method 1600 includes determining partial region “s” corresponding to each frame using the rMap.

At operation 1614, the method 1600 includes performing partial feature detection on the partial regions of the frame. Further, at operation 1616, the method 1600 includes calculating a homography between the frames using the RANSAC. Further, the method 1600 also includes updating the HMap.

At operation 1616, the method 1600 includes updating the Map and partial region “s” based on the calculated homography between the frames.

At operation 1620, the method 1600 may include determining whether all the frames have been processed or not. The method 1600 stops when all the frames have been processed by the advanced RANSAC module 708.

While the above discussed operations in FIG. 16 are shown and described in a particular sequence, the operations may occur in variations to the sequence in accordance with various embodiments.

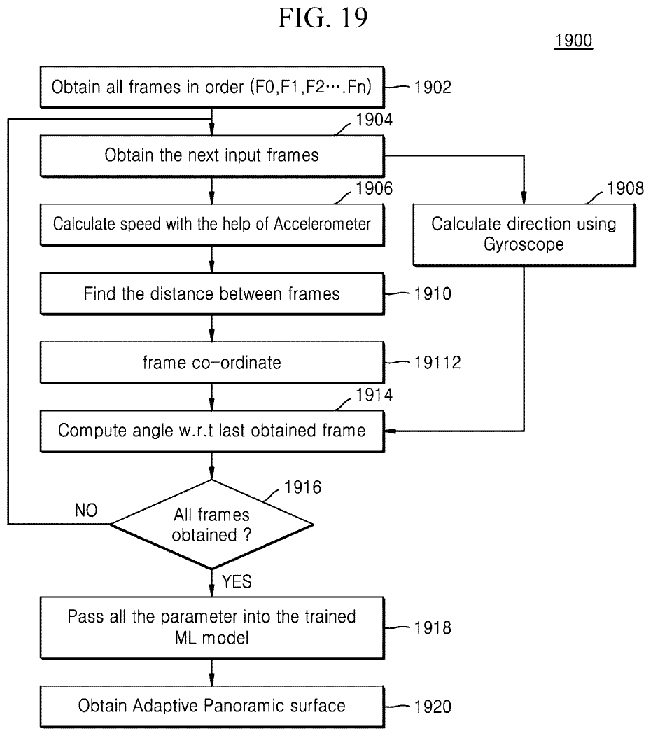

FIG. 17A-17C illustrate 2-D grid generation by the advanced RANSAC module 708, according to an embodiment of the present disclosure. Specifically, FIG. 17 illustrates a generation of 2D grid of the plurality of frames A1-A9. In an embodiment, the advanced RANSAC module 708 may be configured to utilize the inertial sensor data to identify a position of each frame in the 2D grid.

FIG. 17B illustrates position coordinates of two frames in a 3-D space as obtained by the imaging device 702. The advance RANSAC module 708 may utilize the position coordinates in view of following equations to determine at least a distance between the two frame, and 2-D projections:

$$d = \sqrt{{( {x}_{2} - {x}_{1} )}^{2} + {( {y}_{2} - {y}_{1} )}^{2} + {( {z}_{2} - {z}_{1} )}^{2}}$$

$${θ}_{T} ( t ) = {\int }_{0}^{t} v ( t ) dt = {\int }_{0}^{t} {v}_{0} + ( {a}_{s} ( t ) - g ) tdt$$

$${θ}_{R} ( t ) = {\int }_{0}^{t} α ( t ) dt \approx {\sum }_{0}^{t} α ( t ) {t}_{s}$$

FIG. 17C illustrates a projection of frames in 2D plane from each of the position coordinates where the frames were obtained by the imaging device 702.

In an embodiment, the advanced RANSAC module 708 may be configured to utilize following matrix equations to generate the 2D projection G[ ][ ] of the frames:

$$( \begin{matrix}{x}_{1} \\ {x}_{2} \\ {x}_{3}\end{matrix} ) \mathring{=} [ \begin{matrix}1 & 0 & 0 & 0 \\ 0 & 1 & 0 & 0 \\ 0 & 0 & 1 & 0\end{matrix} ] ( \begin{matrix}X \\ Y \\ Z \\ 1\end{matrix} ) = [ I \vert 0 ] ( \begin{matrix}X \\ 1\end{matrix} )$$

$$x = \frac{{x}_{1}}{{x}_{3}} = \frac{X}{Z} y = \frac{{x}_{2}}{{x}_{3}} = \frac{Y}{Z}$$

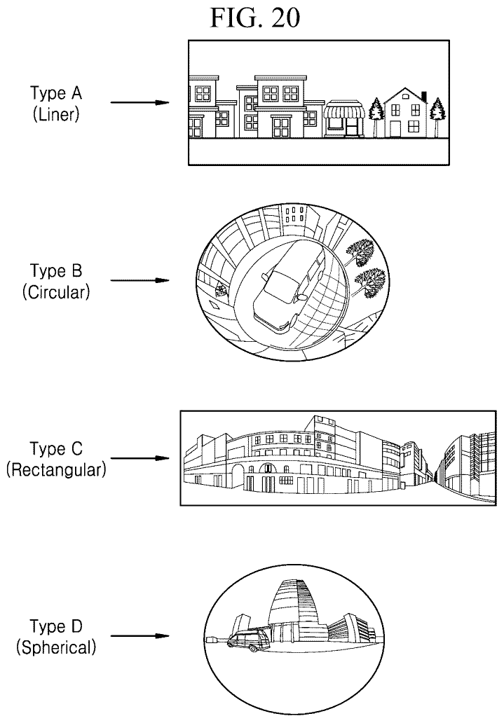

FIGS. 18A-18C illustrate selection of the adaptive panoramic surface selection by the adaptive panoramic surface selection module 710, according to embodiments of the present disclosure. Specifically, FIGS. 18A-18C illustrates determination of an adaptive panoramic surfaces corresponding to the frames based on one or more parameters. In an embodiment, the adaptive panoramic surface selection module 710 may be configured to receive 2D grid projection of frames along with one or more other parameters to select an appropriate panoramic surface for such frames. The one or more other parameters may include, but not limited to, distance matrix, cosine angle of frames, directions of the frames, and a field of view. In an embodiment, a relation between above-mentioned parameters and a panoramic surface selection may be defined by below Table 2:

TABLE 2

| | Distance | Angle | | Field of | Final output |
|---|---|---|---|---|---|
| Input frames | matrix | (Cosine) | Direction | view | (shape) |
| (1.2, 2, 3), (2.5, 2, 3) | 1.4, 0.52, | 0.95, 0.99, 0.96 | (*x.0, 0), (*x, 0, 0), | 150 | Linear |
| (3, 2.1, 3.1), (4.6, | 0.8 | | (*x.0, 0) | | |
| 1.6, 3) | | | | | |
| (0.75, 3, 2.9), (3, | 3.7, 1 | 0.99, 0.93, 0.49, | (+x, 0, −z), (−x, 0, −z), | 360 | Circular |
| 3.1, 0), (2.6, 3, −1.5), | 55.5, 8, | 0.19 | (−x, 0, −z), (+z, 0, +z) | | |
| (−1.5, 3, −2.6), | 0.45 | | | | |
| (−1.1, 3, 2.8) | | | | | |
| (1.2, 3, 4), (2.3, 4.1), | 0.81, 1.1, | 0.99, 0.98, 0.99, | (+x, 0, 0), (+x, 0, 0), | 130 | Rectangular |
| (3.1, 3.1, 4 1) (3.1, | 0.51, 1.12, | 0.99 | (0, +y, 0), (−x, 0, 0), | | |
| 3.6, 4), (2, 3.8, 4.2), | 0.52 | | (−x, 0, 0) | | |
| (1.2, 3.6, 4) | | | | | |
| (2.2, 2, 4), (3.5, 2.4) | 1.3, 0.52, | 0.98, 0.99, 0.99 | (+x, 0, 0), (+x, 0, 0), | 144 | Linear |
| (4, 2.1, 4.1), (4.9, | 0.95 | | (+x, 0, 0) | | |
| 1.6, 4) | | | | | |
| (3.2, 4.4), (4.4, 4.1), | 0.61, 0.14, | 0.99, 0.99, 0.99, | (+x, 0, 0), (+x, 0, 0), | 120 | Rectangular |
| (4.1, 4.1, 4.1) (4.3, | 0.51, 1.12, | 0.98, 0.99 | (0, +y, 0), (−x, 0, 0), | | |
| 4.6, 4), (3, 4.6, 4.2), | 0.82 | | (−x, 0, 0) | | |
| (2.2, 4.6, 4) | | | | | |

Based on the above, FIG. 18A illustrates selection of the adaptive panoramic surface as linear based on linear alignment of frames in 2D projection. FIG. 18B illustrates selection of the adaptive panoramic surface as circular and FIG. 18C illustrates selection of the adaptive panoramic surface as rectangular based on at least alignment of frames in 2D projection and/or one or more above-mentioned parameters.

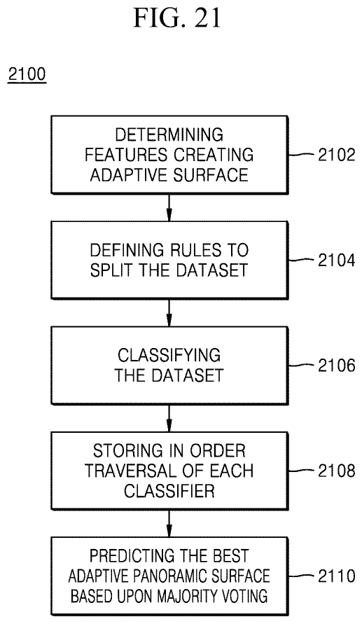

FIG. 19 illustrates a process flow of a method 1900 performed by the adaptive panoramic surface selection module 710 for selection of the adaptive panoramic surfaces, according to an embodiment of the present disclosure.

At operation 1902, the method 1900 includes obtained all the plurality of frames F0-Fn. In an embodiment, the adaptive panoramic surface selection module 710 may receive all the already obtained frames F0-Fn as an input to select an adaptive panoramic surface. Further, the adaptive panoramic surface selection module 710 may be configured to receive the plurality of frames F0-Fn in a sequential order.

At operation 1904, the method 1900 includes obtained next input frames. In an embodiment, the operation 1904 may indicate obtained frames F0-Fn, in a sequential order. In an embodiment, the F0-Fn may refer to already obtained frame and operation 1904 may relate to obtained a next frame after Fn. Further, at operation 1906, the method 1900 includes calculating a speed of the imaging device 702 while obtained the frames using data from the accelerometer sensor. At operation 1908, the method 1900 includes determining a direction of the movement of the imaging device 702, while obtained the frames using data from gyroscope sensor.

At operation 1910, the method 1900 includes determining a direction between each of the plurality of frames F0-Fn. In an embodiment, the adaptive panoramic surface selection module 710 may be configured to determine the direction between each of the plurality of frames based on the calculated speed of the imaging device. The adaptive panoramic surface module 710 may identify a reference position of a first frame and then based on the speed of the imaging device to obtain a second frame, the adaptive panoramic surface module 710 may determine the distance between the first frame and second frame. Similarly, the adaptive panoramic surface selection module 710 may be configured to determine a distance between each of the plurality of frames.

At operation 1912, the method 1900 includes identifying frame co-ordinates corresponding to each of the plurality of frames in a 2D space. In an embodiment, the adaptive panoramic surface selection module 710 may be configured to identify the frame co-ordinates corresponding to each of the plurality of frames based on at least the identified distance between the frames.

At operation 1914, the method 1900 includes identifying an angle of a frame with respect to last obtained frame. In an embodiment, the adaptive panoramic surface selection module 710 may be configured to receive frame co-ordinates and direction of the imaging device 702 while obtained the frame, as inputs to identify the angle of the frame.

At operation 1916, the method 1900 includes determining if all the frames have been obtained or not. Once all the frames have been successfully obtained, the method 1900 may move to operation 1918. At operation 1918, the method 1900 includes passing all the parameters including, frames co-ordinates, the frame distance, the speed, the direction, and the angle into a trained Machine Learning (ML) model. At operation 1920, the method 1900 includes obtaining the adaptive panoramic surface from the trained ML model.

While the above discussed operations in FIG. 19 are shown and described in a particular sequence, the operations may occur in variations to the sequence in accordance with various embodiments.

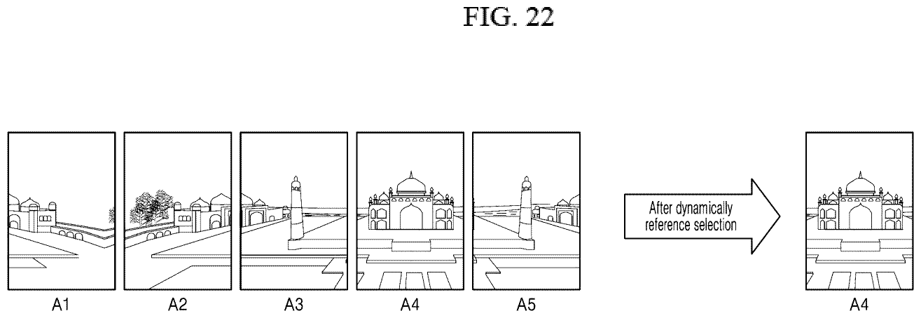

FIG. 20 illustrates panoramic surfaces which may be selected by the adaptive panoramic surface selection module 710, in accordance with an embodiment of the present disclosure. Type A represents a linear adaptive panoramic surface, Type B represents a circular adaptive panoramic surface, Type C represents a rectangular adaptive panoramic surface, and Type D represents a spherical adaptive panoramic surface.

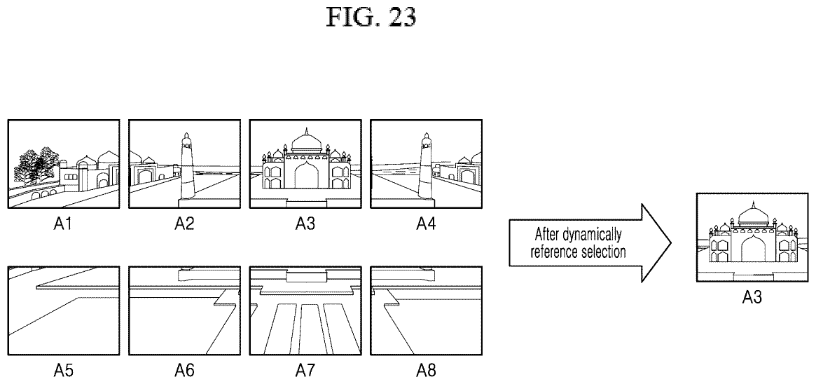

FIG. 21 illustrates a process flow of a method 2100 performed by the adaptive panoramic surface selection module 710, according to an embodiment of the present disclosure. The method 2100 may include determining 2102 features of the frames to identify adaptive panoramic surfaces. In an embodiment, the features may include, but not limited to, a distance between the frames, an angle, and a direction of the frames. In an embodiment, the adaptive panoramic surface selection module 710 may be configured to identify the features based on inputs from accelerometer and gyroscope. The adaptive panoramic surface selection module 710 may be configured to identify a distance between from by following equation:

$$d = \sqrt{{( {x}_{2} - {x}_{1} )}^{2} + {( {y}_{2} - {y}_{1} )}^{2} + {( {z}_{2} - {z}_{1} )}^{2}}$$

where, x₁, y₁ and z₁ corresponds position coordinates of a first frame obtained from the accelerometer and x₂, y₂ and z₂ corresponds position coordinates of a second frame obtained from the accelerometer.

Further, the adaptive panoramic surface selection module 710 may be configured to identify an angle by following equation:

$$cos θ = \vert \frac{{A}_{1} {A}_{2} + {B}_{1} {B}_{2} + {C}_{1} {C}_{2}}{\sqrt{{A}_{1}^{2} + {B}_{1}^{2} + {C}_{1}^{2}} \sqrt{{A}_{2}^{2} + {B}_{2}^{2} + {C}_{2}^{2}}} \vert$$

Moreover, the adaptive panoramic surface selection module 710 may utilize following technique for feature selection:

$$Gini = 1 - {\sum }_{j - 1}^{c} {p}_{j}^{2}$$

$$Entropy = - {\sum }_{j - 1}^{c} {p}_{j} log {p}_{j}$$

The method 2100 may also include defining 2104 rules to split a dataset of the adaptive panoramic surfaces and the identified features. In an embodiment, the method 2100 may include defining 25 rules for decision trees. The decision trees may be a tree-structured classification model. The rules may include, but not limited to, field of view, position change with respect to axis and a frame capture with respect to axis. Further, the method 2100 may include classifying 2106 the dataset corresponding to the adaptive panoramic surfaces and the identified features in a plurality of classifier. In an embodiment, the method 2100 may include classifying the dataset based on 25 rules for the decision trees. Thereafter, the method 2100 may include storing 2108 the dataset corresponding to each classifier in order traversal. At last, the method 2100 may include predicting 2110 the best adaptive panoramic surface based on a highest voting and/or rating.

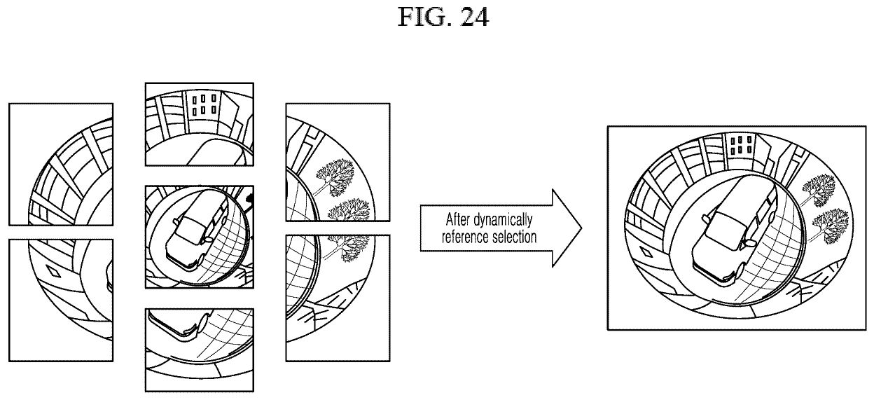

FIG. 22 illustrates selection of a reference frame by the dynamic reference frame selection module 712, according to an embodiment of the present disclosure. FIG. 21 illustrates that the dynamic reference frame selection module 712 may receive five frames A1-A5 and selects A4 as a reference frame. In an embodiment, the dynamic reference frame selection module 712 may be configured to determine a reference frame based on at least on one of a speed of the imaging device 702 while obtained the frame, a distance between the reference frame and one or more neighbouring frames, and the direction of motion of the imaging device 702 while obtained the frame. Further, an relationship between the one or more above-mentioned parameters and the reference frame may be defined by below Table 3:

TABLE 3

| | | | Rate of | Adaptive | Reference |
|---|---|---|---|---|---|
| Input frames | Speed (ms) | No of sharp edges | Change of Intier | surface | frame |
| (A1, A2, A3, A4, A5) | (102, 95, 92, 48, 70) | (100, 120, 140, 300, 200) | (0.5, 0.67, 0.10.2) | Linear | A4 |
| (A1, A2, A3, A4, A5) | (100, 90, 58, 72, 94) | (180, 240, 225, 190, 195) | (0.4, 0 19, 0.2, 0.68) | Circular | A3 |
| (A1, A2, A3, A4, A5, AB) | (92, 68, 100, 8882, 90) | (350, 500, 280, 300, 470) | (0 1, 0.19, 0.6, 0.54) | Rectangle | A2 |
| (A1, A2, A3, A4, A5) | (80, 61.76, 80, 92) | (250, 370, 190, 290, 200) | (0 3, 0 27, 0.7, 0 88) | Linear | A2 |

Further, the table 2 illustrated above is exemplary in nature and the dynamic reference frame selection module 712 may be configured to select any suitable frame as the reference frame to achieve the desired objective. In an embodiment, the dynamic reference frame selection module 712 has selected A4 as a reference based on number of sharp edges in the frame.

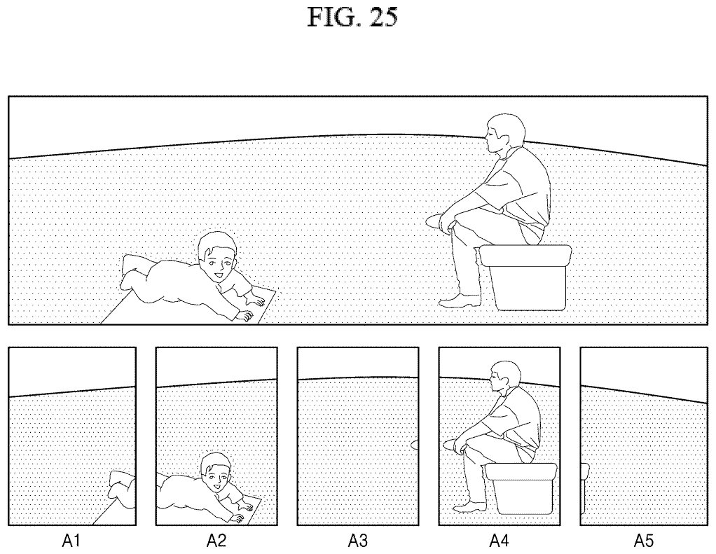

FIG. 23 illustrates selection of a reference frame by the dynamic reference frame selection module 712, according to an embodiment of the present disclosure. In an embodiment of FIG. 23, the dynamic reference frame selection module 712 may consider number of sharp edges and/or a speed of imaging device while obtained the frames as selection criterion for the reference frame. In an embodiment, the sharp edges between the frames may be defined as a difference between the pixels of the frames. A higher the difference may imply a higher number of sharp edges. For example, in an embodiment, from the frames A1-A8, the frame A3 may be considered as the reference frame due a higher number of sharp edges compared to other frames.

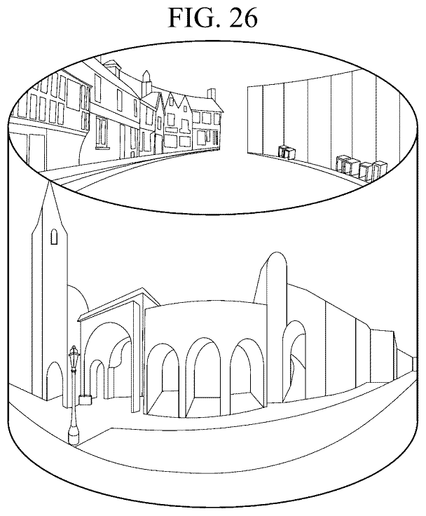

FIG. 24 illustrates selection of reference frame by the dynamic reference frame selection module 712, according to an embodiment of the present disclosure. In an embodiment of FIG. 24, a selection criterion of the reference frame may be the adaptive panoramic surface. In an embodiment, the reference may be selected from any direction which may even include a left most frame or a center frame. For a circular/spherical panoramic surface, as illustrated in FIG. 24, the dynamic reference frame selection module 712 may consider center frame as the reference frame, as the center frame may be more focused. The selection of the reference frame based on the adaptive panoramic surface may reduce error while stitching the frames together to generate the panoramic image 718.

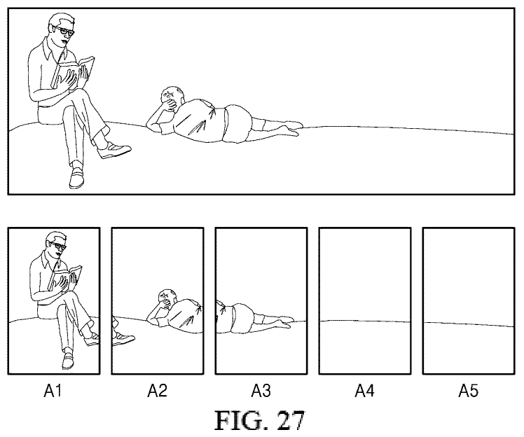

FIG. 25 illustrates selection of a reference frame by the dynamic reference frame selection module 712, according to an embodiment of the present disclosure. In an embodiment of FIG. 25, the dynamic reference frame selection module 712 may consider number of sharp edges as a selection criterion for the reference frame. In an embodiment, the sharp edges between the frames may be defined as a difference between the pixels of the frames. A higher the difference may imply a higher number of sharp edges. For example, in an embodiment, the frames A1 and A3 may not be considered as significant as frames A2 and A4. Therefore, the dynamic reference frame selection module 712 may consider any of frame A2 or A4, as the reference frame. Further, a number of sharp edges may be directly proportional to selection of the reference frame i.e., a higher the number of sharp edges may imply a higher the chance of selection of the frame as the reference frame.

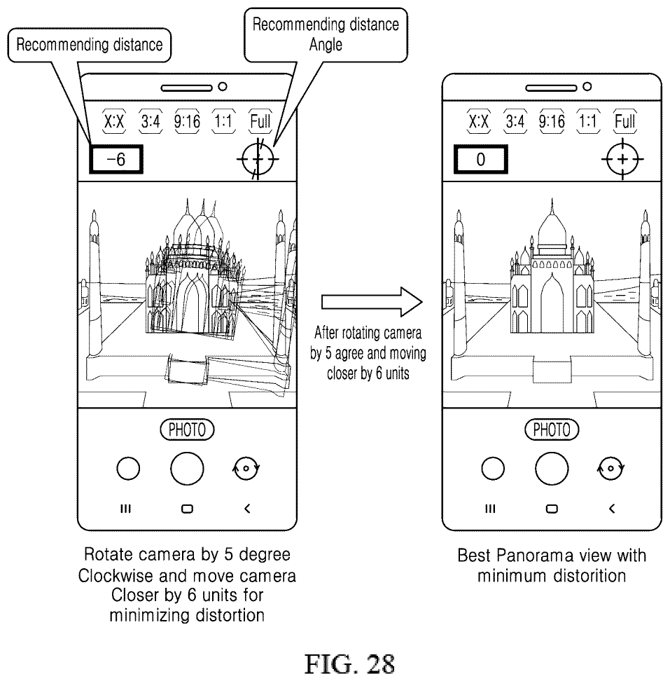

FIG. 26 illustrates selection of reference frame by the dynamic reference frame selection module 712, according to an embodiment of the present disclosure. In an embodiment of FIG. 26, a selection criterion of the reference frame may be the adaptive panoramic surface. In an embodiment, the reference may be selected from any direction which may even include a left most frame or a center frame. For a circular/spherical panoramic surface, as illustrated in FIG. 26, the dynamic reference frame selection module 712 may consider center frame as the reference frame, as the center frame may be more focused. The selection of the reference frame based on the adaptive panoramic surface may reduce error while stitching the frames together to generate the panoramic image 718.

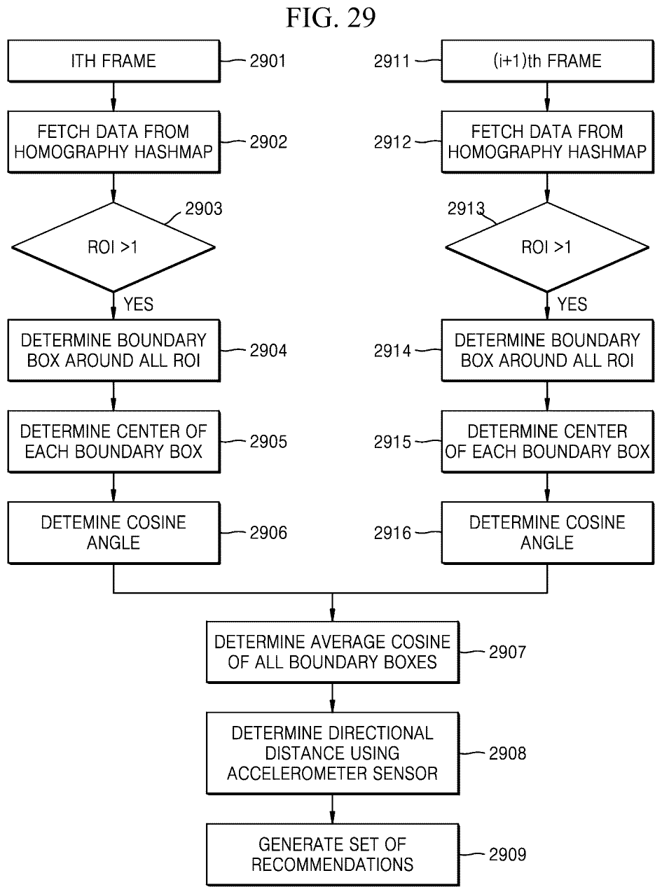

FIG. 27 illustrates selection of reference frame by the dynamic reference frame selection module 712, in accordance with an embodiment of the present disclosure. In an embodiment of FIG. 27, a selection criterion of the reference frame may be a rate of change of inliers in the frames. In an embodiment, the selection of reference frame may be directly proportional to the rate of change of inliers. For instance, in an embodiment, the rate of change of inliers in frames A1-A3 is high as compared to frames A4-A5. Therefore, there are high chances that the dynamic reference frame selection module 712 may consider frames A1-A3 for the selection of the reference frame.

In an embodiment, the number of sharp edges, the speed of camera movement, the adaptive surface, and the rate of change of inlier may be inputted to a trained ML model to identify a score corresponding to each frame and select a frame with a highest score as the reference frame.

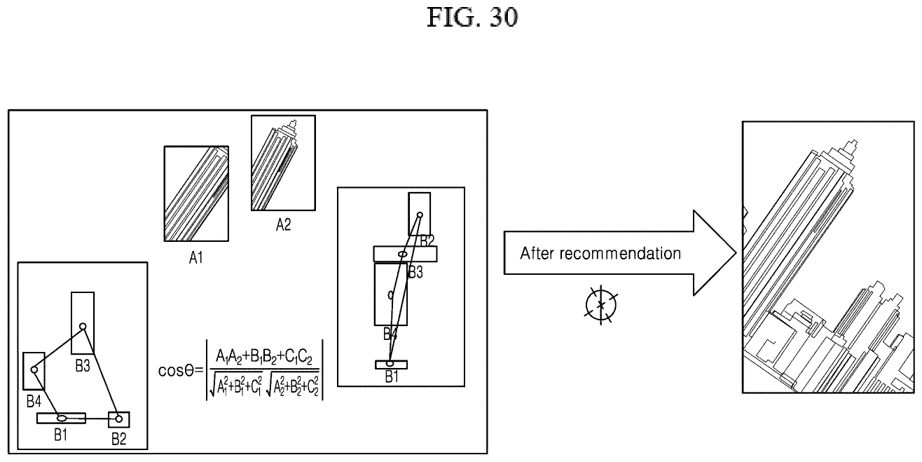

FIG. 28 illustrates generation of recommendations by the recommendation module 714, according to an embodiment of the present disclosure. The recommendation module 714 may be configured to provide one or more recommendations to the user during the obtained of frames for the panoramic image generation. The one or more recommendations may include, but not limited to, a distance between the imaging device and a focused object, and an angle of the frame. In an embodiment, the recommendation module 714 generates recommendations of rotating a camera by 5 degrees clockwise and reduce a distance of the camera and the object by 6 units. The recommendation module 714 may provide said recommendation to reduce distortion in the frames, as also illustrated in FIG. 26.

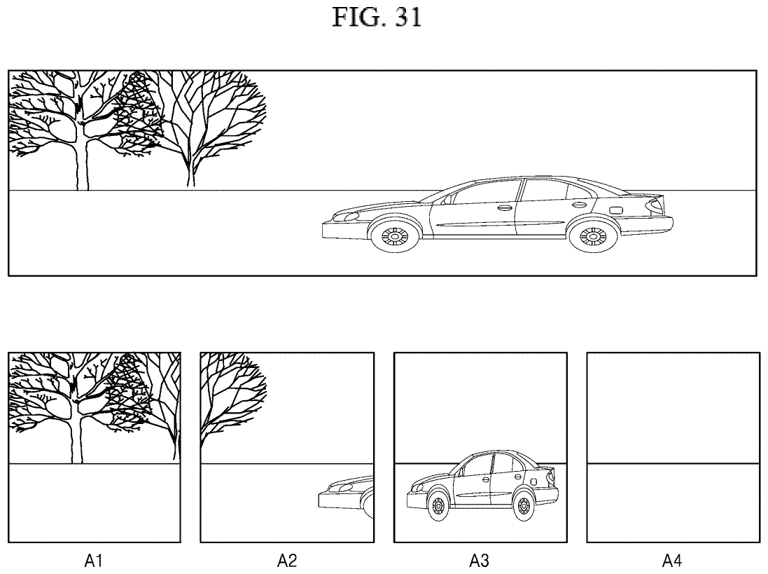

FIG. 29 illustrates a process flow of a method 2900 performed by the recommendation module 714, in accordance with the present disclosure. The method 2900 may include fetching 2902, 2912 information related to homography (i.e., hashmap or Hmap) of a current frame ((i+1)th frame 2911) and a previous frame (ith Frame 2901). For each of the frames, the method 2900 may further include determining 2903, 2913 whether a ROI is present of not. The method 2900 may also determining a number of ROIs. Thereafter, the method 2900 may include determining 2904, 2914 a boundary box around each of the determined ROIs in each frame. Further, the method 2900 may include determining 2905, 2915 a center for each boundary box in both the frames. Also, the method 2900 may include determine 2906, 2916 cosine angles corresponding to each boundary box in each frame. Next, the method 2900 may include determining 2907 an average consider of all the boundary boxes in both the frames. Further, the method 2900 may include determining 2908 a directional distance between the frames using inertial sensor data. At last, the method 2900 may include generating 2909 a set of recommendation based on the determined data/information.

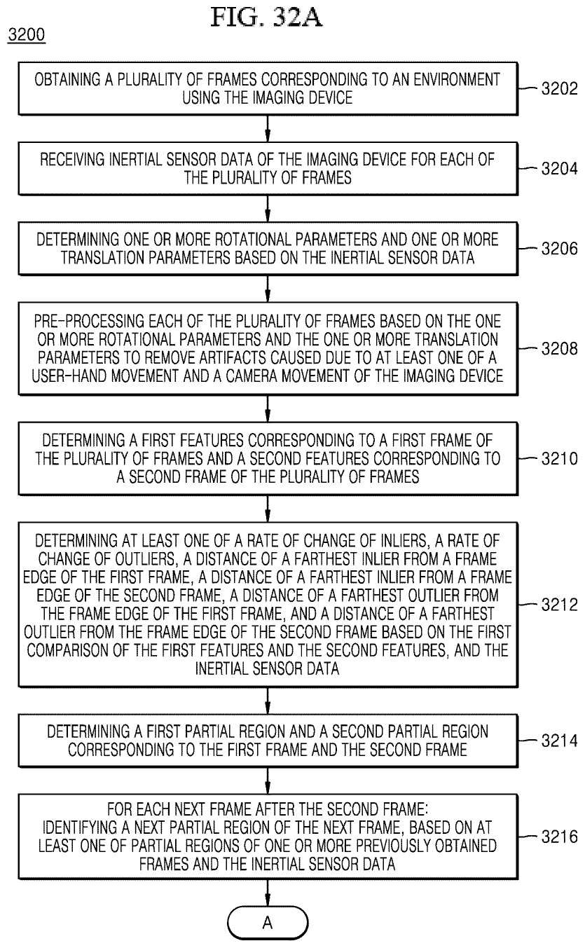

FIG. 30 illustrates impact of recommendations by the recommendation module 714, according to an embodiment of the present disclosure. As discussed in reference to FIG. 29, the recommendation module 714 may be configured to determine ROIs, and corresponding boundary boxes in each frame. Further, the recommendation module 714 may determine a center of each boundary box and direction data corresponding to the frames. Thereafter, the recommendation module 714 may determine cosine corresponding to each boundary box using the equation illustrated in FIG. 30. Then, the recommendation module 714 may generate a set of recommendation to effectively align the frames to generate the panoramic image.

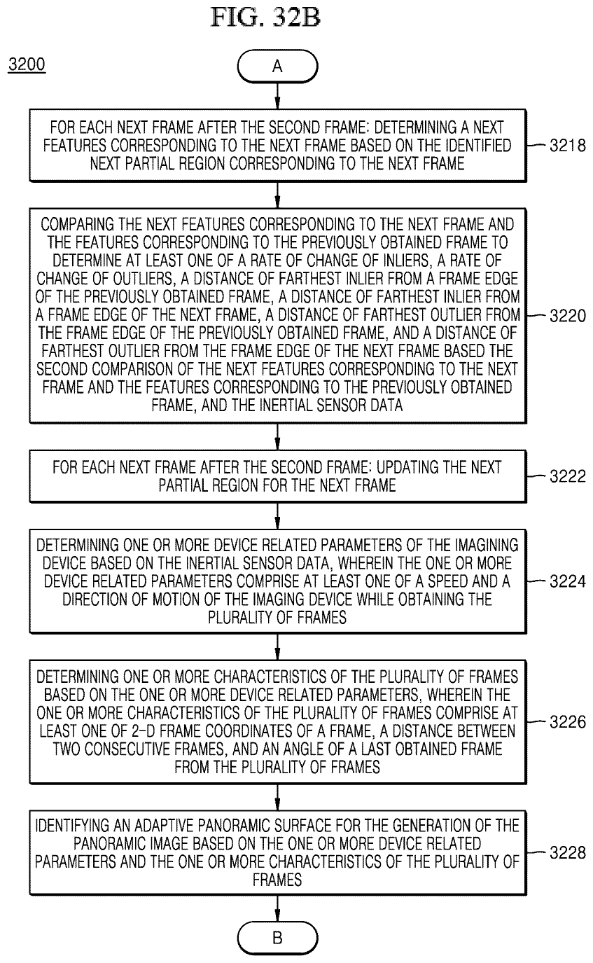

FIG. 31 illustrates frame calibration by the ISP frame capture calibration module 716, in accordance with the present disclosure. The ISP frame capture calibration module 716 may be configured to modify one or more properties of camera ISP based on environment. The ISP frame capture calibration module 716 may be configured to assist the imaging device 702 to decide when to obtain a next frame. The ISP frame capture calibration module 716 may be configured to calibrate a frame capture rate based on one or more parameter which includes, but not limited to, a speed of camera movement, an overlapping between neighboring frames, and a speed of moving object. In an embodiment, the frame capture rate may be inversely proportional to the speed of camera movement, the frame capture rate may be directly proportional to overlapping between the neighboring frames, and the frame capture rate may be directly proportional to the speed of the moving object in the frame. Thus, the ISP frame capture calibration module 716 may be configured to modify the frame capture rate to improve over efficiency of the panoramic image generation electronic device 601.

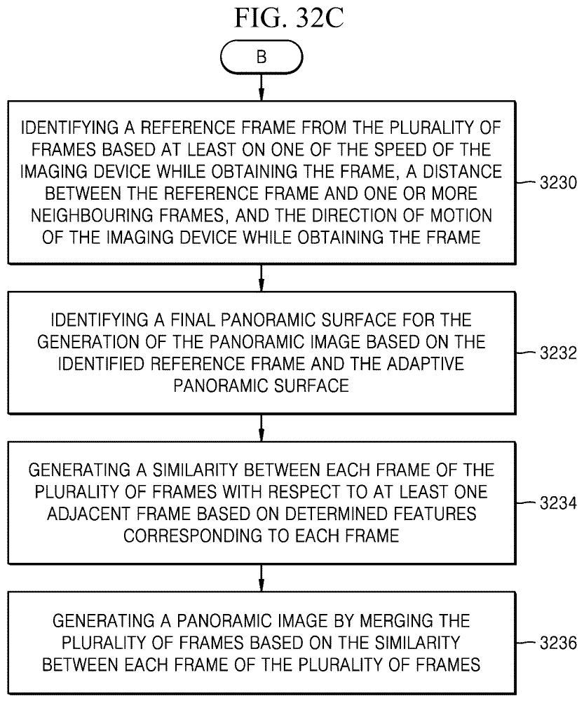

FIGS. 32A-32C illustrate a process of a method 3200 for generating a panoramic image, according to an embodiment of the present disclosure.

At operation 3202, the method 3200 includes obtained a plurality of frames corresponding to an environment using the imaging device 702.

At operation 3204, the method 3200 includes receiving inertial sensor data of the imaging device 702 for each of the plurality of frames. At operation 3206, the method 3200 further includes determining one or more rotational parameters and one or more translation parameters based on the inertial sensor data. Further, at operation 3208, the method 3200 includes pre-processing each of the plurality of frames based on the one or more rotational parameters and the one or more translation parameters to remove artifacts caused due to at least one of a user-hand movement and a camera movement of the imaging device 702.

At operation 3210, the method 3200 includes determining a first features corresponding to a first frame of the plurality of frames and a second features corresponding to a second frame of the plurality of frames. At operation 3212, the method further includes determining at least one of a rate of change of inliers, a rate of change of outliers, a distance of a farthest inlier from a frame edge of the first frame, a distance of a farthest inlier from a frame edge of the second frame, a distance of a farthest outlier from the frame edge of the first frame, and a distance of a farthest outlier from the frame edge of the second frame based on the first comparison of the first features and the second features, and the inertial sensor data. In an embodiment, each of the inliers is a similar feature in the first frame and the second frame and each of the outliers is a distinctive feature in the first frame and the second frame. Further, the frame edge of the first frame and the frame edge of the second frame are adjacent to each other.

At operation 3214, the method 3200 includes determining a first partial region corresponding to the first frame and a second partial region corresponding to the second frame, based on a first comparison of the first features and the second features.

At operation 3216, the method 3200 includes identifying a next partial region of the next frame based on at least one of partial regions of one or more previously obtained frames and the inertial sensor data, for each next frame after the second frame.

At operation 3218, the method 3200 includes determining next features corresponding to the next frame based on the identified next partial region corresponding to the next frame. At operation 3220, the method 3200 further includes comparing the next features corresponding to the next frame and the features corresponding to the previously obtained frame to determine at least one of a rate of change of inliers, a rate of change of outliers, a distance of farthest inlier from a frame edge of the previously obtained frame, a distance of farthest inlier from a frame edge of the next frame, a distance of farthest outlier from the frame edge of the previously obtained frame, and a distance of farthest outlier from the frame edge of the next frame based the second comparison of the next features corresponding to the next frame and the features corresponding to the previously obtained frame, and the inertial sensor data.

At operation 3222, the method 3200 includes updating the next partial region for the next frame based on the second comparison of the next features and features corresponding to the previously obtained frame.

At operation 3224, the method 3200 includes determining one or more device related parameters of the imaging device based on the inertial sensor data. The one or more device related parameters comprise at least one of a speed and a direction of motion of the imaging device while obtained the plurality of frames. At operation 3226, the method 3200 includes determining one or more characteristics of the plurality of the frames based on the one or more device related parameters. The one or more characteristics of the plurality of frames comprise at least one of 2-D frame coordinates of a frame, a distance between two consecutive frames, and an angle of a last obtained frame from the plurality of frames. Further at operation 3228, the method 3200 includes identifying an adaptive panoramic surface for the generation of the panoramic image based on the one or more device related parameters and the one or more characteristics of the plurality of frames.

At operation 3230, the method 3200 includes identifying a reference frame from the plurality of frames based at least on one of the speed of the imaging device while obtained the frame, a distance between the reference frame and one or more neighboring frames, and the direction of motion of the imaging device while obtained the frame. Further at operation 3232, the method 3200 includes identifying a final panoramic surface for the generation of the panoramic image based on the identified reference frame and the adaptive panoramic surface

At operation 3232, the method 3200 includes generating a similarity between each frame of the plurality of frames with respect to at least one adjacent frame based on determined features corresponding to each frame. The similarity between each frame of the plurality of frames with respect to the at least one adjacent frame indicates a relationship between at least one of an inlier and an outlier identified based on third comparison of the each frame and the at least one adjacent frame.

At operation 3234, the method 3200 includes generating a panoramic image by merging the plurality of frames based on the similarity of the plurality of frames.

As the above operations 3202-3234 are discussed previously in detail in conjunction with FIGS. 7-31, these are not discussed in detail here again for the sake of brevity. While the above discussed operations in FIG. 32 are shown and described in a particular sequence, the operations may occur in variations to the sequence in accordance with various embodiments.

The purpose of this disclosure is to address various technical problems, which are not restricted solely to the ones mentioned earlier. Any other technical problems not explicitly stated here will be readily understood by those skilled in the art from the following disclosure.

According to an embodiment of the disclosure, an electronic device may comprise a memory and at least one processor communicably coupled to the memory. The at least one processor may be configured to obtain a plurality of frames corresponding to an environment using the imaging device. The at least one processor may be configured to receive inertial sensor data of the imaging device for each of the plurality of frames. The at least one processor may be configured to determine a first features corresponding to a first frame of the plurality of frames and a second features corresponding to a second frame of the plurality of frames. The at least one processor may be configured to determine a first partial region corresponding to the first frame and a second partial region corresponding to the second frame, based on a first comparison of the first features and the second features. For each next frame after the second frame, the at least one processor may be configured to identify a next partial region of the next frame based on at least one of partial region of one or more previously obtained frames and the inertial sensor data. The at least one processor may be configured to determine next features corresponding to the next frame based on the identified next partial region corresponding to the next frame. The at least one processor may be configured to update the next partial region for the next frame based on a second comparison of the next features and features corresponding to the previously obtained frame. The at least one processor may be configured to generate a similarity between each frame of the plurality of frames with respect to at least one adjacent frame based on determined features corresponding to each frame. The at least one processor may be configured to generate a panoramic image by merging the plurality of frames based on the similarity between each frame of the plurality of frames.

According to an embodiment of the disclosure, the at least one processor may be configured to determine at least one of a rate of change of inliers, a rate of change of outliers, a distance of a farthest inlier from a frame edge of the first frame, a distance of a farthest inlier from a frame edge of the second frame, a distance of a farthest outlier from the frame edge of the first frame, and a distance of a farthest outlier from the frame edge of the second frame based on the first comparison of the first features and the second features, and the inertial sensor data. The at least one processor may be configured to determine the first partial region and the second partial region corresponding to the first frame and the second frame based on the first features and the second features, and at least one of the rate of change of inliers, the rate of change of outliers, the distance of the farthest inlier from the frame edge of the first frame, the distance of the farthest inlier from the frame edge of the second frame, the distance of the farthest outlier from the frame edge of the first frame, and the distance of the farthest outlier from the frame edge of the second frame.

According to an embodiment of the disclosure, each of the inliers is a similar feature in the first frame and the second frame, wherein each of the outliers is a distinctive feature in the first frame and the second frame, and wherein the frame edge of the first frame and the frame edge of the second frame are adjacent to each other

According to an embodiment of the disclosure, the at least one processor may be configured to compare the next features corresponding to the next frame and the features corresponding to the previously obtained frame to determine at least one of a rate of change of inliers, a rate of change of outliers, a distance of farthest inlier from a frame edge of the previously obtained frame, a distance of farthest inlier from a frame edge of the next frame, a distance of farthest outlier from the frame edge of the previously obtained frame, and a distance of farthest outlier from the frame edge of the next frame based the second comparison of the next features corresponding to the next frame and the features corresponding to the previously obtained frame, and the inertial sensor data. The at least one processor may be configured to update the next partial region for the next frame based on the next features and a features corresponding to the previously obtained frame, and at least one of the rate of change of inliers, the rate of change of outliers, the distance of farthest inlier from the frame edge of the previously obtained frame, the distance of farthest inlier from the frame edge of the next frame, the distance of farthest outlier from the frame edge of the previously obtained frame, and the distance of farthest outlier from the frame edge of the next frame.

According to an embodiment of the disclosure, the similarity between each frame of the plurality of frames with respect to the at least one adjacent frame indicates a relationship between at least one of an inlier and an outlier identified based on a third comparison of the each frame and the at least one adjacent frame.

According to an embodiment of the disclosure, prior to determining the first features and the second features, the at least one processor may be configured to determine one or more rotational parameters and one or more translation parameters based on the inertial sensor data. The at least one processor may be configured to pre-process each of the plurality of frames based on the one or more rotational parameters and the one or more translation parameters to remove artifacts caused due to at least one of a user-hand movement and a camera movement of the imaging device.

According to an embodiment of the disclosure, a computer readable medium for storing computer readable program code or instructions which are executable by a processor to perform a method of receiving a voice command. The method may include obtaining a plurality of frames corresponding to an environment using the imaging device. The method may include receiving inertial sensor data of the imaging device for each of the plurality of frames. The method may include determining a first features corresponding to a first frame of the plurality of frames and a second features corresponding to a second frame of the plurality of frames. The method may include determining a first partial region corresponding to the first frame and a second partial region corresponding to the second frame, based on a first comparison of the first features and the second features. For each next frame after the second frame, the method may include identifying a next partial region of the next frame, based on at least one of partial regions of one or more previously obtained frames and the inertial sensor data. The method may include determining next features corresponding to the next frame based on the identified next partial region corresponding to the next frame. The method may include updating the next partial region for the next frame based on a second comparison of the next features and features corresponding to a previously obtained frame. The method may include generating a similarity between each frame of the plurality of frames with respect to at least one adjacent frame based on determined features corresponding to each frame. The method may include generating a panoramic image by merging the plurality of frames based on the similarity between each frame of the plurality of frames.

The present disclosure provides for various technical advancements based on the key features discussed above. For instance, the present disclosure may enable effective, accurate and efficient generation of panoramic image.

Specifically, the present disclosure reduces computational resources and time required for generating the panoramic image.

Further, the present disclosure enables generation of panoramic image with minimum or no distortion.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

What is claimed is:

1. A method for processing a panoramic image, the method executed by at least one processor, the method comprising:
obtaining a plurality of frames corresponding to an environment using an imaging device;
receiving inertial sensor data of the imaging device associated with the plurality of frames;
obtaining first features associated with a first frame of the plurality of frames and second features associated with a second frame of the plurality of frames;
obtaining a first partial region of the first frame and a second partial region of the second frame, based on a first comparison of the first features and the second features;
for each subsequent frame after the second frame:
identifying a next partial region of a next frame, based on at least one of partial regions of one or more previously obtained frames and the inertial sensor data,
obtaining next features associated with the next frame based on the next partial region of the next frame, and
updating the next partial region of the next frame based on a second comparison of the next features and features associated with a previously obtained frame;
generating a similarity between a respective frame of the plurality of frames and at least one adjacent frame to the respective frame based on obtained features associated with each frame; and
generating a panoramic image by merging the plurality of frames based on the similarity between each frame of the plurality of frames.

2. The method of claim 1, further comprising:
obtaining, based on the first comparison and the inertial sensor data, at least one of a rate of change of inliers, a rate of change of outliers, a distance of a farthest inlier from a frame edge of the first frame, a distance of a farthest inlier from a frame edge of the second frame, a distance of a farthest outlier from the frame edge of the first frame, and a distance of a farthest outlier from the frame edge of the second frame; and
obtaining the first partial region and the second partial region based on the first features and the second features, and at least one of the rate of change of inliers, the rate of change of outliers, the distance of the farthest inlier from the frame edge of the first frame, the distance of the farthest inlier from the frame edge of the second frame, the distance of the farthest outlier from the frame edge of the first frame, and the distance of the farthest outlier from the frame edge of the second frame.

3. The method of claim 2, wherein an inlier is a similar feature in the first frame and the second frame, wherein an outlier is a distinctive feature in the first frame and the second frame, and wherein the frame edge of the first frame and the frame edge of the second frame are adjacent to each other.

4. The method of claim 1, further comprising:
obtaining, based on the second comparison and the inertial sensor data, at least one of:
a rate of change of inliers, a rate of change of outliers, a distance of farthest inlier from a frame edge of the previously obtained frame, a distance of farthest inlier from a frame edge of the next frame, a distance of farthest outlier from the frame edge of the previously obtained frame, and a distance of farthest outlier from the frame edge of the next frame; and
updating the next partial region for the next frame based on the next features, the features associated with the previously obtained frame, and at least one of the rate of change of inliers, the rate of change of outliers, the distance of farthest inlier from the frame edge of the previously obtained frame, the distance of farthest inlier from the frame edge of the next frame, the distance of farthest outlier from the frame edge of the previously obtained frame, and the distance of farthest outlier from the frame edge of the next frame.

5. The method of claim 1, wherein the similarity between the respective frame of the plurality of frames and the at least one adjacent frame to the respective frame indicates a respective relationship between at least one of an inlier and an outlier identified based on a third comparison of the respective frame and the at least one adjacent frame.

6. The method of claim 1, further comprising:
prior to obtaining the first features and the second features:
obtaining one or more rotational parameters and one or more translation parameters based on the inertial sensor data; and
pre-processing each of the plurality of frames based on the one or more rotational parameters and the one or more translation parameters to remove artifacts caused due to a user-hand movement or a camera movement of the imaging device.

7. The method of claim 1, further comprising:
obtaining one or more device related parameters of the imaging device based on the inertial sensor data, wherein the one or more device related parameters comprise at least one of a speed of the imaging device while obtaining the plurality of frames and a direction of motion of the imaging device while obtaining the plurality of frames;
determining one or more characteristics of the plurality of frames based on the one or more device related parameters, wherein the one or more characteristics of the plurality of frames comprise at least one of 2-D frame coordinates, a distance between two consecutive frames, and an angle of a last obtained frame from the plurality of frames; and
identifying an adaptive panoramic surface for the generation of the panoramic image based on the one or more device related parameters and the one or more characteristics of the plurality of frames.

8. The method of claim 7, further comprising:
identifying a reference frame from the plurality of frames based at least on one of the speed of the imaging device while obtaining the reference frame, a distance between the reference frame and one or more neighboring frames, and the direction of motion of the imaging device while obtaining the reference frame; and
identifying a final panoramic surface for the generation of the panoramic image based on the reference frame and the adaptive panoramic surface.

9. An electronic device comprising:
memory;
at least one processor communicably coupled to the memory, the at least one processor is configured to:
obtain a plurality of frames corresponding to an environment using the imaging device;
receive inertial sensor data of the imaging device associated with the plurality of frames;
obtain a first features associated with a first frame of the plurality of frames and a second features associated with a second frame of the plurality of frames;
obtain a first partial region of the first frame and a second partial region of the second frame, based on a first comparison of the first features and the second features;
for each subsequent frame after the second frame:
identify a next partial region of a next frame based on at least one of partial region of one or more previously obtained frames and the inertial sensor data,
determine next features associated with the next frame based on the next partial region of the next frame, and
update the next partial region of the next frame based on a second comparison of the next features and features associated with the previously obtained frame;
generate a similarity a respective frame of the plurality of frames and at least one adjacent frame to the respective frame based on obtained features associated with each frame; and
generate a panoramic image by merging the plurality of frames based on the similarity between each frame of the plurality of frames.

10. The electronic device of claim 9, wherein the at least one processor is configured:
obtain, based on the first comparison and the inertial sensor data, at least one of a rate of change of inliers, a rate of change of outliers, a distance of a farthest inlier from a frame edge of the first frame, a distance of a farthest inlier from a frame edge of the second frame, a distance of a farthest outlier from the frame edge of the first frame, and a distance of a farthest outlier from the frame edge of the second frame; and
obtain the first partial region and the second partial region based on the first features and the second features, and at least one of the rate of change of inliers, the rate of change of outliers, the distance of the farthest inlier from the frame edge of the first frame, the distance of the farthest inlier from the frame edge of the second frame, the distance of the farthest outlier from the frame edge of the first frame, and the distance of the farthest outlier from the frame edge of the second frame.

11. The electronic device of claim 10, wherein an inlier is a similar feature in the first frame and the second frame, wherein an outlier a distinctive feature in the first frame and the second frame, and wherein the frame edge of the first frame and the frame edge of the second frame are adjacent to each other.

12. The electronic device of claim 9, wherein the at least one processor is further configured to:
obtain, based on the second comparison and the inertial sensor data, at least one of a rate of change of inliers, a rate of change of outliers, a distance of farthest inlier from a frame edge of the previously obtained frame, a distance of farthest inlier from a frame edge of the next frame, a distance of farthest outlier from the frame edge of the previously obtained frame, and a distance of farthest outlier from the frame edge of the next frame; and
update the next partial region for the next frame based on the next features, the features associated with the previously obtained frame, and at least one of the rate of change of inliers, the rate of change of outliers, the distance of farthest inlier from the frame edge of the previously obtained frame, the distance of farthest inlier from the frame edge of the next frame, the distance of farthest outlier from the frame edge of the previously obtained frame, and the distance of farthest outlier from the frame edge of the next frame.

13. The electronic device of claim 9, wherein the similarity between the respective frame of the plurality of frames and the at least one adjacent frame to the respective frame indicates a respective relationship between at least one of an inlier and an outlier identified based on a third comparison of the respective frame and the at least one adjacent frame.

14. The electronic device of claim 9, wherein the at least one processor is further configured to:
prior to obtaining the first features and the second features:
obtain one or more rotational parameters and one or more translation parameters based on the inertial sensor data; and
pre-process each of the plurality of frames based on the one or more rotational parameters and the one or more translation parameters to remove artifacts caused due to a user-hand movement or a camera movement of the imaging device.

15. A non-transitory computer readable medium storing one or more instructions that when executed cause at least one processor of an electronic device to:
obtain a plurality of frames corresponding to an environment using the imaging device;
receive inertial sensor data of the imaging device associated with the plurality of frames;
obtain a first features associated with a first frame of the plurality of frames and a second features associated with a second frame of the plurality of frames;
obtain a first partial region of the first frame and a second partial region of the second frame, based on a first comparison of the first features and the second features;
for each subsequent frame after the second frame:
identify a next partial region of a next frame based on at least one of partial region of one or more previously obtained frames and the inertial sensor data,
determine next features associated with the next frame based on the next partial region of the next frame, and
update the next partial region of the next frame based on a second comparison of the next features and features associated with the previously obtained frame;
generate a similarity a respective frame of the plurality of frames and at least one adjacent frame to the respective frame based on obtained features associated with each frame; and
generate a panoramic image by merging the plurality of frames based on the similarity between each frame of the plurality of frames.
